(19) United States
(12) Patent Application Publication
(10) Pub. No.: US 2015/0216182 A1
(43) Pub. Date: Aug. 6, 2015

(54) COMPOSITIONS AND METHODS OF THE ATTRACTION AND REPULSION OF INSECTS

(71) Applicant: Olfactor Laboratories, Inc., Riverside, CA (US)

(72) Inventors: Michelle Ardella Brown, Hemet, CA (US); Martin Antonio Lomeli, JR., Moreno Valley, CA (US); Samer Elkashef, Moreno Valley, CA (US); Tricia Zion, Trabuco Canyon, CA (US); Ulises Frutos, Colton, CA (US)

(21) Appl. No.: 14/422,044

(22) PCT Filed: Aug. 16, 2013
(86) PCT No.: PCT/US13/55330

§ 371 Date: Feb. 17, 2015

Related U.S. Application Data
(60) Provisional application No. 61/684,242, filed on Aug. 17, 2012.
(60) Provisional application No. 61/805,172, filed on Mar. 26, 2013.
(60) Provisional application No. 61/858,931, filed on Jul. 26, 2013.

(51) Int. Cl. A01N 65/22; A01N 43/60; A01N 43/08; A01N 37/02; A01N 37/42; A01N 25/34; A01N 35/06; A01N 43/40; A01N 43/38

(52) U.S. Cl. CPC A01N 65/22; A01N 43/40; A01N 43/60; A01N 43/08; A01N 43/38; A01N 37/42; A01N 25/34; A01N 35/06; A01N 37/02

(57) ABSTRACT

The present invention provides insect attractants and repellents as well as methods of trapping and/or altering the behavioral patterns of vector pests such as mosquitoes and other hematophagous pests.

### CROSS REFERENCE TO RELATED APPLICATIONS

This application claims priority to U.S. Provisional Patent Application No. 61/684,242 filed Aug. 17, 2012, entitled Compositions and Methods for the Attraction and Repulsion of Insects, U.S. Provisional Patent Application No. 61/805,172 filed Mar. 26, 2013, entitled Compositions and Methods for the Attraction and Repulsion of Insects and U.S. Provisional Patent Application No. 61/858,931 filed Jul. 26, 2013, entitled Compositions and Methods for the Attraction and Repulsion of Insects, the contents of each of which are herein incorporated by reference in their entireties.

### FIELD OF THE INVENTION

The present invention relates to the field of insect attractants and repellents as well as methods of trapping and/or altering the behavioral patterns of vector pests such as mosquitoes and other hematophageous pests, and the like.

### BACKGROUND OF THE INVENTION

Mosquito-borne illnesses are responsible for the deaths of more than one million people annually. Malaria is one such illness posing a major health problem in tropical and subtropical regions. Another global killer is the Dengue virus, transmitted by Aedes aegypti which infects 100 million people annually primarily in Latin America and Asia. Mosquito-borne illnesses are also on the rise in the United States. Since the first reported human infections in New York State in 1999, the West Nile Virus has steadily moved south and west with detection currently recorded in all of the States of the continental United States. Eastern Equine Encephalitis (EEE) is another arbovirus transmitted by mosquitoes that is also causing illness in individuals in the United States as well as in Central and South America. Serious infections of EEE are characterized by seizures and coma leading to death in about half of these patients. Therefore, there exists a worldwide need for safe, effective and affordable agents to protect humans from mosquitoes and other vector pests.

Many previous methods as well as methods in current practice for controlling mosquito populations rely on chemicals that are harmful to human health as well as to plant and animal species in the environment. One such chemical is N,N-diethyl-meta-toluamide (DEET). DEET was registered as an insect repellent in 1957 after first being used by the military in 1946. There are over 225 DEET containing products registered for use on skin and/or clothing making it the most widely utilized insect repellent in the market. Unfortunately, DEET poses a health hazard in mammals, having been shown to inhibit acetylcholinesterase, an enzyme affecting muscle control. Since the introduction of DEET, very few novel compounds have made it into the market.

One compound that has been introduced since DEET is permethrin. Permethrin is an insecticidal neurotoxin that destabilizes the cell membrane of neurons eventually leading to insect death. Mammalian toxicity for permethrin is low, but it can cause harm when coming in contact with the eyes or lungs. Also, the toxicity of permethrin to aquatic animals and aquatic ecosystems is high. With increasing awareness of the harmful effects of these chemicals and their control methods, there remains a need in the field to develop methods, compounds and compositions for controlling insect populations and insect behavior with minimal risk to humans and the environment.

It is known that female mosquitoes track vertebrate blood-meals primarily through carbon dioxide (CO2) emissions in exhaled breath (Gillies M. T., The role of carbon dioxide in host-finding by mosquitoes (Diptera: Culicidae): a review. Bull. Entomology Res. 1980. 70:525-532). CO2 is sensed in specialized neurons in the mosquito maxillary palp that express heteromeric CO2-receptor proteins, highly conserved across the order Diptera. Recent studies utilizing electrophysiology and behavior assays have demonstrated that certain small molecules can stimulate or inhibit the CO2 receptor (Turner, S. L. et al., Ultra prolonged activation of CO2-sensing neurons disorients mosquitoes. Nature. 2011 Jun. 2; 474(7349):87-91). Such molecules that inhibit the CO2 receptor are currently being explored in the field as mosquito deterrents (or repellents), while molecules that stimulate mosquito CO2 receptor activity are attractive targets for use in insect traps. It is also the case that strong and prolonged activators of CO2 receptor activity can have a “masking” effect, with concomitant repellent outcomes, because prolonged activation would saturate the CO2 receptor signaling, thereby rendering the mosquito unable to track CO2 plumes. In this situation, even CO2 receptor activators would be considered repellents for purposes of reducing their contact with subjects (e.g. humans and other animals, including but not limited to cattle, horses, cats, dogs, and pigs) and their areas of habitation.

The present invention provides compounds and compositions that directly interact with the CO2-responsive machinery. These compositions are desirable for use in mosquito control due to their specificity and low toxicity. The compounds described herein include a number of natural products as well as structurally similar synthetic molecules, potentially making these compounds less harmful to the environment and to human health.

Thus, the methods and compositions described herein which activate and/or inhibit CO2 receptor activity in vector pests represent a solution to address the long felt need for improved vector pest control with minimal risk to humans and the environment.

### SUMMARY OF THE INVENTION

In some embodiments, the present invention provides compounds and/or compositions that alter or modify the behavior of vector pests. Some such compositions may comprise at least one of compounds OLI0001-OLI0121. Such compositions may comprise a compound selected from the group consisting of compounds OLI0001-OLI0013. Such compounds may be present at a concentration of from about 0.01% to about 5%.

In some embodiments, compositions of the present invention may comprise a combination of two compounds, wherein at least one compound is selected from the group consisting of OLI0001-OLI0004, OLI0006-OLI0008, OLI0010, OLI0011, OLI0013-OLI0015, OLI0017, OLI0018, OLI0020-OLI0022, OLI0024, OLI0025, OLI0027, OLI0096, OLI0097 and OLI0099. Compounds within such compositions may be present at a concentration of from about 0.01% to about 5%. In some cases, at least one compound is a beta activator selected from the group consisting of OLI0027, OLI0096, OLI0097 and OLI0099. Some compositions may comprise a combination of two compounds, wherein each compound is independently selected from the group consisting of OLI0006, OLI0008, OLI0013-OLI0022, OLI0024-OLI0029, OLI0063, OLI0091, OLI0092, OLI0096-OLI0100. Compounds within such compositions may be present at a concentration of from about 0.01% to about 5%. Some such compositions may comprise at least one beta activator selected from the group consisting of OLI0027 and OLI0096-OLI0100.

In some embodiments, compositions may comprise a synergistic combination of compounds. Some compositions may comprise at least one compound selected from the group consisting of OLI0014-OLI0018, OLI0022, OLI0024, OLI0025, OLI0027 and OLI0029. Some such compositions may comprise at least one other compound selected from the group consisting of OLI0019-OLI0021, OLI0025, OLI0026, OLI0028, OLI0063, OLI0091, OLI0092 and OLI0100.

In some embodiments, compositions of the present invention may comprise a compound selected from the group consisting of OLI0067-OLI0070. Some such compositions may comprise a combination of two compounds, wherein at least one compound is selected from the group consisting of OLI0015, OLI0067-OLI0078, OLI0080, OLI0082-OLI0084, OLI0089, OLI0093, OLI0095, OLI0100 and OLI0102. Some compounds within such compositions may be present at a concentration of from about 0.01% to about 5%. Some such compositions may comprise at least one beta activator selected from the group consisting of OLI0074, OLI0084 and OLI0100. In some cases, such compositions may comprise a synergistic combination. In some cases, such compositions may comprise at least one environmentally friendly compound selected from the group consisting OLI0076, OLI0093 and OLI0102.

In some embodiments, compositions of the present invention may comprise a combination of three compounds, wherein each compound is individually selected from the group consisting of OLI0068, OLI0071, OLI0072, OLI0074, OLI0078, OLI0080, 0110100 and OLI0102. Such compositions may comprise at least one environmentally friendly compound, selected from the group consisting of OLI0076, OLI0093 and OLI0102. Such compositions may comprise at least one beta activator selected from the group consisting of OLI0074 and OLI0100. Some compositions may comprise a synergistic combination comprising at least one compound selected from the group consisting of OLI0071, OLI0093 and OLI0102. Such compositions may comprise at least one other compound selected from the group consisting of OLI0015, OLI0072-OLI0078, OLI0080, OLI0082-OLI0084, OLI0089, OLI0095 and OLI0100.

In some embodiments, the present invention provides methods of modifying the behavior of a vector pest comprising exposing said vector pest to a composition of the present invention. Some such methods may comprise increased CO2 responsive neuronal activity and/or CO2 receptor activity in said vector pest. In some such methods, the vector pest is a flying dipteran, mosquito, sand fly, black fly, tsetse fly, biting midge, bed bug, assassin bug, flea, louse, mite and/or tick. Compositions of some such methods comprise a compound selected from the group consisting of compounds OLI0001-OLI0013. Compositions of other methods comprise a combination of two compounds, wherein at least one compound is selected from the group consisting of OLI0001-OLI0004, OLI0006-OLI0008, OLI0010, OLI0011, OLI0013-OLI0015, OLI0017, OLI0018, OLI0020-OLI0022, OLI0024, OLI0025, OLI0027, OLI0096, OLI0097 and OLI0099. The concentration of some such compounds may be from about 0.5% to about 5%.

According to some methods, flying dipterans selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)) may be affected.

In some embodiments, methods of the present invention may comprise the use of compositions comprising a combination of two compounds, wherein each compound is independently selected from the group consisting of OLI0006, OLI0008, OLI0013-OLI0022, OLI0024-OLI0029, OLI0063, OLI0091, OLI0092, OLI0096-OLI0100. Some such methods may be used to in the control of vector pests that may include flyting dipterans, mosquitoes, sand flies, black flies, tsetse flies, biting midges, bed bugs, assassin bugs, fleas, lice, mites or ticks. Flying dipterans may be selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)). According to some such methods, compounds may be present as concentrations from about 0.5% to about 5%. According to some methods, composition may comprise synergistic combinations of compounds. Such synergistic combinations may be selected from the group consisting of OLI0014-OLI0018, OLI0022, OLI0024, OLI0025, OLI0027 and OLI0029. According to other synergistic methods, at least one other compound may be selected from the group consisting of OLI0019-OLI0021, OLI0025, OLI0026, OLI0028, OLI0063, OLI0091, OLI0092 and OLI0100.

In some embodiments, methods of the present invention may comprise vector pest behavioral modification comprising reduced CO2 responsive neuronal activity and/or CO2 receptor activity in said vector pest. Some such methods may comprise the use of composition wherein compounds are selected from the group consisting of OLI0067-OLI0070. According to some such methods, vector pests may be selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)).

Some methods may comprise the use of a composition wherein the composition comprises a combination of two compounds, wherein at least one compound is selected from the group consisting of OLI0015, OLI0067-OLI0078, OLI0080, OLI0082-OLI0084, OLI0089, OLI0093, OLI0095, OLI0100 and OLI0102. In some cases the concentration of at least one compound may be from about 0.01% to about 5%. In some cases, the vector pest is a flying dipteran selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)).

In some embodiments, methods of the present invention may comprise compositions comprising a combination of three compounds, wherein each compound is individually selected from the group consisting of OLI0068, OLI0071, OLI0072, OLI0074, OLI0078, OLI0080, 0110100 and OLI0102. Compounds within such compositions may be present at concentrations of from about 0.01% to about 5%. In some embodiments, such methods may be used to modify the behavior of a flying dipteran, wherein the flying dipteran is selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)).

In some embodiments, methods of the present invention may be used to modify the behavior of a bed bug. Such methods may comprise the use of at least one compound selected from the group consisting of OLI0001-OLI0012, OLI0014-OLI0022, OLI0024-OLI0029, OLI0052, OLI0059, OLI0063, OLI0065-OLI0072, OLI0074, OLI0076-OLI0079, OLI0084, OLI0091-OLI0093, OLI0095-OLI0097, OLI0099-OLI0102, 0110104-OLI0107, 0110109-OLI0115 and OLI0118-OLI0121. In some cases, bed bugs are repelled by such compositions. In some embodiments, bed bug repellent compositions may comprise at least one compound selected from the group consisting of OLI0014-OLI0017, OLI0020, OLI0024, OLI0029 and OLI0102. According to other methods, compositions may be used to attract bed bugs. Attractant compositions according to such methods may comprise a combination of at least two compounds, wherein at least one compound is selected from the group consisting of OLI0007, OLI0008 and OLI0010.

In some embodiments, methods of the present invention may biocidal toward one or more vector pests and may comprise the use of one or more compositions of the present invention. Such methods may comprise the use of compositions comprising one or more biocidal agents selected from the group consisting of OLI0001-OLI0003, OLI0005, OLI0006, OLI009, OLI0011-OLI0014, OLI0016, OLI0017, OLI0019, OLI0020, OLI0021, OLI0024-OLI0029, OLI0052, OLI0059, OLI0065-OLI0077, OLI0079, OLI0084, OLI0091, OLI0092, OLI0096, OLI0097 and OLI0100-OLI0119. Such compositions may comprise biocidal agents at a concentration of from about 0.2 mg/ml to about 2 mg/ml. Such biocidal agents may affect one or more of a flying dipteran, mosquito, sand fly, black fly, tsetse fly, biting midge, bed bug, assassin bug, flea, louse, mite and/or tick. In some embodiments, biocidal agents are present at a concentration of from about 50 ppm to about 150 ppm. In other compositions, biocidal agents may be present at a concentration of from about 0.1% to about 0.5%. In other embodiments, such methods comprise compositions comprising one or more larvicidal agents selected from the group consisting of OLI0001-OLI0003, OLI0005, OLI0006, OLI0008, OLI0009, OLI0011-OLI0014, OLI0016, OLI0017, OLI0019, OLI0020, OLI0024-OLI0029, OLI0052, OLI0059, OLI0065-OLI0077, OLI0079, OLI0084, OLI0091, OLI0092, OLI0096, OLI0097, OLI0100-OLI0102, 0110104-OLI0107 and OLI0109-OLI0119. Such larvicidal agents may comprise larvicidal activity toward larvae from one or more of a flying dipteran, mosquito, sand fly, black fly, tsetse fly or biting midge.

In some embodiments, the present invention provides devices comprising at least one of compounds OLI0001-OLI0102. Some such devices may comprise a patch. Such patches may comprise one or more materials selected from the group consisting of paper, plastic, metal, fabric, wax, polymeric materials, polyethylene, polypropylene, rubber, cellulose, silicon rubber and cellulose-based materials. In some cases, patches may comprise an area from about 1 cm² to about 5 cm². Some patches may comprise a shape selected from the group consisting of a circle, a square, a rectangle, a triangle and a polygon. In some cases, patches may comprise an adhesive. Some patches may comprise a film or paper layer to protect said adhesive prior to application of said patch. Some patches may be square in shape with side lengths comprising 1.5 cm each. Some patches may be applied to a subject's skin, clothing or apparel.

In some embodiments, devices of the present invention may be placed inside or attached to a holder selected from the group consisting of a pocket, a compartment, a cassette, a box or a clip. Such holders may be attached to a subject using an accessory device selected from the group consisting of a bracelet, a necklace, a wrist band, a collar, an arm band, an article of clothing or a clip-on device. In some embodiments, accessory devices may comprise an air diffuser.

### BRIEF DESCRIPTION OF THE DRAWINGS

The foregoing and other objects, features and advantages will be apparent from the following description of particular embodiments of the invention, as illustrated in the accompanying drawings. The drawings are not necessarily to scale, emphasis instead being placed upon illustrating the principles of various embodiments of the invention.

FIG. 1 is an electrophysiology trace illustrating a comparison between an activator, and inhibitor and control. The response is quantified as spikes/second in the adjacent histogram. The figure illustrates the basal activity of the carbon dioxide receptor with paraffin oil, the solvent for the chemicals tested using electrophysiology (top panel), compared to 1% concentrations of an inhibitor, 2-methoxy-3-methylpyridine (middle panel), and an activator, 2,4-lutidine (bottom panel). 2-methoxy-3-methylpyridine is approved for fragrance use and has a “nutty” odor. 2,4-lutidine has a “green” odor, is approved for cosmetic fragrance use and is listed by the Flavor and Extract Manufacturers Association (FEMA) as a GRAS compound (Generally Recognized As Safe).

FIG. 2 is a histogram of data obtained from a landing assay. The landing assay is designed to identify lures for Aedes aegypti. The data of the histogram indicate that compounds cyclopentanone and 2-pentanone act as lures as compared to control. 2-ethylpyrazine is an activator of CO2 receptors that can act as a repellent in this assay.

FIG. 3 is a histogram of data obtained from a netsphere assay. The “netsphere assay” as used herein is a semi-field trail assay used to identify compounds that can serve as lures or repellents in a large area. The histogram depicts a sampling using compounds cyclopentanone and 2-pentanone, which have been previously shown to be lures, and can act over large areas to attract mosquitoes. The controls included a carbon dioxide positive control and a repellent compound, 2,4-lutidine. This experiment was performed with Aedes aegypti mosquitoes.

### DETAILED DESCRIPTION OF THE INVENTION

Given the tremendous impact vector pests have on the human condition, it is of great interest and imperative that compositions and methods be developed to minimize the deleterious effects these species have on the transmission of disease in animal species, especially humans and domesticated animals.

Described herein are compositions (including pharmaceutical compositions) and methods for the design, preparation and manufacture of compounds which alter the behavior of vector pests in a manner that is beneficial to animals, particularly humans. Such altered behavior may be the result of exposing a vector pest to compounds or compositions of the present invention in multiple forms. As used herein, the term “exposing” refers to applying a compound or composition to an object, surface, area, or region in such a manner and in sufficient proximity to a vector pest as to allow the sensing of the compound or composition by the vector pest. The resulting behavioral alteration may be induced by a compound or composition in the form of an attractant to a site distant from humans or human habitation or it may be induced by a compound or composition in the form of a repellent resulting in the pests being deterred from coming to or toward human beings or their habitats. It may also be induced by the use of a receptor activator in concentrations that saturate the response with the ultimate outcome resulting in a masking of the receptor sense. Consequently an activating compound may also become a vector pest repellent. As used herein, an “attractant” is any compound, composition or combination capable of attracting one or more pests, whereas a “repellent” is any compound, composition or combination capable of repelling or deterring one or more pests. Attractants may be used as a bait or lure in a trap. As used herein, a “bait” or “lure” is any compound, composition combination, object or chemically treated object capable of attracting one or more pests to a trap. Regardless of directionality, the objective of the present invention is the provision of compounds, compositions and methods which ameliorate, reduce, or eliminate the deleterious effects on human (or animal) health caused by pests, especially vector pests. As such, the compounds, compositions and/or combinations of the present invention are useful for the prevention of vector-borne illnesses in individuals, groups of individuals or large populations as well as the spread of said illnesses. Said illnesses include, but are not limited to malaria, dengue, yellow fever, sleeping sickness, West Nile virus, Eastern equine encephalitis, river blindness, lymphatic filariasis, leishmaniasis, epidemic polyarthritis, Australian encephalitis and the like.

As used herein, a “pest” refers to any one of a number of species that cause harm, irritation, discomfort or general annoyance to humans or other animals. “Vector pests” are those organisms that are capable of carrying and/or transmitting a viral, bacterial, protozoan or other pathogen from reservoir to host.

Most vector pests are arthropod insects and may be hematophagous. Pests or vector pests may also include biting insects. Vector pests which are of the order Hemiptera may include, but are not limited to assassin bugs of the subfamily Triatominae (including, but not limited to members of the genus Melanolestes, Platymeris, Pselliopus, Rasahus, Reduvius, Sinea, Triatoma and Zelus) and bed bugs of the genus Cimex (including, but not limited to Cimex lectularius). Vector pests which are fleas of the order Siphonaptera may include, but are not limited to members of the genus Ctenocephalides (including, but not limited to Ctenocephalides felis and Ctenocephalides canis), Pulex (including, but not limited to Pulex irritans), Dasypsyllus, Nosopsyllus and Xenopsylla. Vector pests which are of the order Ixodida may include, but are not limited to ticks of the family Nuttalliellidae (including Nuttalliella namaqua), Ixodidae (including, but not limited to Ixodes scapularis, Ixodes holocyclus, Ixodes hexagonus, Ixodes pacificus, Ixodes ricinus and Ixodes uriae) and Argasidae. Vector pests which are lice of the order Phthiraptera may include, but are not limited to members of the genus Pediculus (including, but not limited to Pediculus humanus capitis and Pediculus humanus humanus) and members of the genus Pthirus (including, but not limited to Pthirus pubis). Vector pests which are of the order Diptera, including flying dipterans (the term “flying dipterans” as used herein refers to any members of the order Diptera that are capable of flight) may include, but are not limited to, members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, members of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia and members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)).

### Carbon Dioxide (CO2) Response or Activity Targeting

The present invention provides compounds and compositions useful to activate, saturate and/or inhibit the activity of CO2-responsive neurons, the receptors of which are conserved across different species of vector pests and are expressed by neurons in the antennae or maxillary palp. As used herein, a “CO2 receptor” is a receptor or other cellular protein capable of sensing, binding or otherwise responding to CO2 or to changes in CO2 levels. A “CO2-responsive neuron” is a neuron capable of directly sensing CO2 or responds to changes in CO2 levels and in which activity correlates with those levels.

As used herein, “neuronal activity” refers to cellular impulses that can be detected using electrophysiological methods.

In one embodiment, the compounds and compositions disclosed are activators of CO2-responsive neurons. As used herein, an “activator” is any compound, composition or combination capable of stimulating neuronal activity in CO2-responsive neurons. Activators may alter vector pest behavior in varying ways and as such may act as attractants or inhibitors depending on the application.

Activation, measured in spikes per second (spk/sec), may be reflected in an activity of by about 20-300 spikes per second (spk/sec), by about 20-200 spk/sec, by about 20-100 spk/sec, by about 20-80 spk/sec, by about 20-60 spk/sec, by about 20-40 spk/sec, by about 40-300 spk/sec, by about 40-200 spk/sec, by about 40-100 spk/sec, by about 40-80 spk/sec, by about 40-60 spk/sec, by about 60-300 spk/sec, by about 60-200 spk/sec, by about 60-100 spk/sec, by about 60-80 spk/sec, by about 100-300 spk/sec or by about 100-200 spk/sec. A “spike” refers to an impulse of neuronal activity as recorded through extracellular single-sensillum electrophysiology.

Activators of the present invention are divided into mild, moderate, strong and very strong. A “mild activator” is a compound, composition or combination that is able to directly activate CO2-responsive neurons resulting in a spike rate of 20-40 spk/sec over the baseline activity of the neuron. A “moderate activator” is a compound, composition or combination that is able to directly activate CO2-responsive neurons resulting in a spike rate of 40-60 spk/sec over the baseline activity of the neuron. A “strong activator” is a compound, composition or combination that is able to directly activate CO2-responsive neurons resulting in a spike rate of 60-100 spk/sec over the baseline activity of the neuron. A “very strong activator” is a compound, composition or combination that is able to directly activate CO2-responsive neurons resulting in a spike rate of over 100 spk/sec over the baseline activity of the neuron. Where activators are delivered in saturating concentrations to the effect of producing a repellent response, these compounds, compositions or combinations are referred to as “masking” agents. Masking agents, therefore may also be termed repellents or deterrents.

In some embodiments, activator compounds of the present invention may comprise any of those listed in Table 1.

TABLE 1
Activator compounds

| Compound | |
|---|---|
| No. | Compound |
| OLI0001 | 2,4-lutidine |
| OLI0002 | 2-ethylpyrazine |
| OLI0003 | 2-methoxypyrazine |
| OLI0004 | 2-methyltetrahydrofuran-3-one |
| OLI0005 | 4-ethylphenol |
| OLI0006 | 5-methyl furfural |
| OLI0007 | butyl formate |
| OLI0008 | cyclopentanone |
| OLI0009 | ethyl 2-furoate |
| OLI0010 | ethyllactate |
| OLI0011 | ethylvinylcarbinol |
| OLI0012 | guaiacol |
| OLI0013 | trans-2-methyl-2-butenal |
| OLI0014 | 2,3,5-trimethylpyrazine |
| OLI0015 | 2,3-dimethylpyrazine |
| OLI0016 | 2-acetyl-5-methyl furan |
| OLI0017 | 2-furyl methyl ketone |
| OLI0018 | 2-pentanone |
| OLI0019 | allyl butyrate |
| OLI0020 | cinnamyl nitrile |
| OLI0021 | ethyl 3-hydroxyhexanoate |
| OLI0022 | ethylacetoacetate |
| OLI0023 | ethylvinylketone |
| OLI0024 | gamma-heptalactone |
| OLI0025 | methanethiol acetate |
| OLI0026 | methyl crotonate |
| OLI0027 | methyl levulinate |
| OLI0028 | phenylacetaldehyde |
| OLI0029 | phenylpropylaldehyde |
| OLI0030 | 2,4-dimethyl benzaldehyde |
| OLI0031 | 2,4-dimethyl-3-cyclohexene- |
| | carboxaldehyde (mixture of cis/trans |
| | forms) |
| OLI0032 | 2-ethyl-5(6)-methylpyrazine |
| OLI0033 | 2-methoxy-4-methylphenol |
| OLI0034 | 2-phenylpropionaldehyde |
| OLI0035 | 3-hexanone |
| OLI0036 | 4-ethylbenzaldehyde |
| OLI0037 | 4-oxoisophorone |
| OLI0038 | acetyl-2-pyrazine |
| OLI0039 | butan-3-one-2yl butanoate |
| OLI0040 | dimethyl succinate |
| OLI0041 | dipropylenglykol-monomethyl ether |
| OLI0042 | ethyl 3-hydroxybutyrate |
| OLI0043 | ethyl-2,3,5(6)-dimethyl pyrazine |
| OLI0044 | ethylformate |
| OLI0045 | ethylisobutyrate |
| OLI0046 | ethylisovalerate |
| OLI0047 | ethyllevulinate |
| OLI0048 | furfurylethylether |
| OLI0049 | heptaldehyde |
| OLI0050 | heptanone-4 |
| OLI0051 | hexanal |
| OLI0052 | indole |
| OLI0053 | isobutyl acetate |
| OLI0054 | isobutyl propionate |
| OLI0055 | isobutyl trans-2-butenoate |
| OLI0056 | isopropyl butyrate |
| OLI0057 | isopropyl tiglate |
| OLI0058 | methyl isovalerate |
| OLI0059 | methylheptadienone |
| OLI0060 | m-tolualdehyde |
| OLI0061 | o-anisaldehyde |
| OLI0062 | prenylacetate |
| OLI0063 | propyl formate |
| OLI0064 | R-+ pulegone |
| OLI0065 | trans-cinnamaldehyde |
| OLI0066 | valeraldehyde |

In one embodiment the compounds and compositions disclosed are inhibitors of CO2-responsive neurons. As used herein, an “inhibitor” is any compound, composition or combination capable of reducing neuronal activity in CO2-responsive neurons. Inhibitors may alter pest behavior in varying ways and as such may act as pest attractants or repellents depending on the application.

Inhibition, measured as relative reduction of activity, may be reflected in reduced activity of about 20-100%, by about 20-80%, by about 20-60%, by about 20-40%, by about 40-100%, by about 40-80%, by about 40-60%, by about 60-100% or by about 60-80%.

Inhibitors of the present invention are divided into mild, moderate and strong inhibitors. A “mild inhibitor” is a compound, composition or combination that is able to directly inhibit CO2-responsive neuronal activity resulting in a 20-40% reduction in neuronal activity as compared to baseline activity of the neuron. A “moderate inhibitor” is a compound, composition or combination that is able to directly inhibit CO2-responsive neuronal activity resulting in a 40-60% reduction in neuronal activity as compared to baseline activity of the neuron. A “strong inhibitor” is a compound, composition or combination that is able to directly inhibit CO2-responsive neuronal activity resulting in a greater than 60% reduction in neuronal activity as compared to baseline activity of the neuron.

In some embodiments, inhibitor compounds of the present invention may include, but are not limited to any of those listed in Table 2.

TABLE 2
Inhibitor compounds

| Compound | |
|---|---|
| No. | Compound |
| OLI0067 | 2,3-diethyl-5-methylpyrazine |
| OLI0068 | 2,3-diethylpyrazine |
| OLI0069 | 2-ethyl-3-methylpyrazine |
| OLI0070 | 2-methoxy-3-methylpyrazine |
| OLI0071 | 2-ethyl-3-methoxypyrazine |
| OLI0072 | 2-methoxy-3(5or6)isopropylpyrazine |
| OLI0073 | cis-3-hexenyl acetate |
| OLI0074 | furfurylpentanoate |
| OLI0075 | octanone-3 |
| OLI0076 | Phenethyl propionate |
| OLI0077 | trans-2-decenal |
| OLI0078 | (Z)-hept-3-enylacetate |
| OLI0079 | 1-ethylhexyl tiglate |
| OLI0080 | 1-octanol |
| OLI0081 | 2,5-dimethyl-4-methoxy-3(2H) furanone |
| OLI0082 | alpha,alpha-dimethyl phenethyl butyrate |
| OLI0083 | cis-3-hexenyl butyrate |
| OLI0084 | cis-5-octen-1-ol |
| OLI0085 | ethyl nicotinate |
| OLI0086 | Ethylheptanoate |
| OLI0087 | Eucalyptol |
| OLI0088 | furfurylpentenoate |
| OLI0089 | Geranylacetone |
| OLI0090 | Geranylbutyrate |
| OLI0091 | methyl heptanoate |
| OLI0092 | methylamylketone |
| OLI0093 | rosemary oil |
| OLI0094 | whiskey lactone |
| OLI0095 | Veratraldehyde |

### Beta Activators

Three types of CO2-responsive neurons reside in the maxillary palp of mosquitoes. These include cpA, cpB and cpC neurons. While activity from cpA neurons produces the largest amplitude spike during electrophysiological analysis, cpB and cpC neurons present in this region are responsive to skin odors (Lu, T. et al., Odor coding in the maxillary palp of the malaria vector mosquito Anopheles gambiae. Curr Biol. 2007 Sep. 18; 17(18):1533-44. Epub 2007 Aug. 30). These neurons produce spikes with much lower amplitude than those produced by cpA neurons. Although the activity from cpB and cpC neurons cannot easily be distinguished from one another, their collective activity can be distinguished from cpA neurons due to their characteristic spikes. This is useful in the identification of compounds and compositions that only activate or inhibit cpB and cpC neurons or compounds and compositions that activate or inhibit both. As used herein, the term “beta activator” refers to any compound or composition that can stimulate cpB and cpC neuronal activity.

In some embodiments, beta activator compounds of the present invention may include, but are not limited to any of those listed in Table 3.

TABLE 3
Beta activator compounds

| Compound | |
|---|---|
| No. | Compound |
| OLI0096 | cis-3-hexenyl formate |
| OLI0097 | hexyl formate |
| OLI0098 | isoamyl formate |
| OLI0099 | isoamyl propionate |
| OLI0100 | methyl (E)-hex-3-enoate |
| OLI0101 | peppermint oil |
| OLI0074 | furfurylpentanoate |
| OLI0084 | cis-5-octen-1-ol |
| OLI0079 | 1-ethylhexyl tiglate |
| OLI0027 | methyl levulinate |

### Synergistic Compositions

It has been unexpectedly found that certain compounds of the inventions, when combined produce synergistic outcomes with regard to their effect on neuronal activity. For example, some combinations were found to be strong activators although comprising only mild or moderate activator compounds. Likewise, other combinations were found to be synergistic inhibitors although comprising only mild or moderate inhibitor compounds. In addition, synergistic combinations were identified which act as either activators or inhibitors despite comprising a compound that individually displayed the opposite function when applied as a single compound.

Biocidal and/or Lethal Compounds

Some compositions of the present invention may comprise biocidal agents, also referred to herein as “biocides.” As used herein, the term “biocidal agent” or “biocide” refers to any agent capable of controlling (e.g. retarding growth, retarding reproduction, repelling, neutralizing harmful effects, sterilizing, immobilizing and/or killing) a biological organism. In some embodiments, such organisms are pests. In some embodiments, such pests are vector pests (e.g. a flying dipteran, mosquito, sand fly, black fly, tsetse fly, biting midge, bed bug, assassin bug, flea, louse, mite or tick.) As used herein, the term “biocidal activity” refers to the controlling capability of a given biocide. In some embodiments, biocides may be larvicides. As used herein, the term “larvicide” refers to an agent that exhibits biocidal activity toward one or more larvae. Such larvae may be pest larvae. In some cases, pest larvae comprise vector pest larvae (e.g. dipteran larvae, mosquito larvae or larvae from a sand fly, black fly, tsetse fly or biting midge.)

In some embodiments, biocides of the present invention are lethal. As used herein the term “lethal” is used to refer to any agent capable of causing death in one or more organisms that are exposed to such an agent. In some embodiments, such organisms are pests. In some embodiments, such pests are vector pests. As used herein, the term “lethality” refers to the capability of a given agent to cause death in one or more organisms exposed to such an agent.

In some embodiments, biocidal compounds and/or compositions of the present invention may comprise one or more of the compounds listed in Table 4.

TABLE 4
Biocidal compounds

| Compound | |
|---|---|
| No. | Compound |
| OLI0005 | 4-ethylphenol |
| OLI0020 | cinnamyl nitrile |
| OLI0021 | ethyl 3-hydroxyhexanoate |
| OLI0029 | phenylpropylaldehyde |
| OLI0052 | Indole |
| OLI0076 | phenethylpropionate |
| OLI0077 | trans-2-decenal |
| OLI0079 | 1-ethylhexyl tiglate |
| OLI0084 | cis-5-octen-1-ol |
| OLI0102 | Eugenol |
| OLI0103 | phenethyl cinnamate |
| OLI0104 | allyl cinnamate |
| OLI0105 | trans-cinnamyl propionate |
| OLI0106 | cinnamic aldehyde dimethyl acetal |
| OLI0107 | cinnamyl formate |
| OLI0108 | cinnamyl isobutyrate |
| OLI0109 | cinnamyl propionate |
| OLI0110 | ethyl cinnamate |
| OLI0111 | Menthalactone |
| OLI0112 | methoxy cinnamic aldehyde |
| OLI0113 | methyl cinnamate |
| OLI0114 | methyl trans-cinnamate |

Compositions with biocidal activity may comprise biocidal compounds at varying concentrations. In some embodiments, concentrations of biocidal compounds in such compositions may be measured in parts per million (ppm.) Some compositions may comprise from about 0.1 ppm to about 2 ppm, from about 1 ppm to about 10 ppm, from about 5 ppm to about 50 ppm, from about 50 ppm to about 150 ppm, from about 100 ppm to about 200 ppm, from about 200 ppm to about 500 ppm, from about 500 ppm to about 1000 ppm or at least 1000 ppm. In other embodiments, compositions may comprise biocidal compounds at concentrations of from about 0.1% to about 0.5%, from about 0.25% to about 1.5%, from about 1% to about 10%, from about 5% to about 20%, from about 10% to about 30%, from about 15% to about 35%, from about 20% to about 40%, from about 30% to about 50%, from about 40% to about 60%, from about 50% to about 75% or at least 75%. In still other embodiments, biocidal compounds may be present in biocidal compositions at concentrations of from about 0.01 mg/ml to about 0.1 mg/ml, from about 0.2 mg/ml to about 2 mg/ml, from about 1 mg/ml to about 4 mg/ml, from about 2 mg/ml to about 5 mg/ml, from about 5 mg/ml to about 10 mg/ml, from about 10 mg/ml to about 20 mg/ml, from about 15 mg/ml to about 30 mg/ml, from about 25 mg/ml to about 50 mg/ml, from about 40 mg/ml to about 60 mg/ml, from about 50 mg/ml to about 75 mg/ml, from about 70 mg/ml to about 100 mg/ml, from about 100 mg/ml to about 500 mg/ml, from about 500 mg/ml to about 1 g/ml or at least 1 g/ml.

In some embodiments, larvicidal compounds and/or compositions of the present invention may comprise one or more of the compounds listed in Table 5.

TABLE 5
Larvicidal compounds

| Compound | |
|---|---|
| No. | Compound |
| OLI0001 | 2,4-lutidine |
| OLI0002 | 2-ethylpyrazine |
| OLI0003 | 2-methoxypyrazine |
| OLI0005 | 4-ethylphenol |
| OLI0006 | 5-methyl furfural |
| OLI0008 | Cyclopentanone |
| OLI0009 | ethyl 2-furoate |
| OLI0011 | ethyl vinyl carbinol |
| OLI0012 | Guaiacol |
| OLI0013 | trans-2-methyl-2-butenal |
| OLI0014 | 2,3,5-trimethylpyrazine |
| OLI0016 | 2-acetyl-5-methyl furan |
| OLI0017 | 2-furyl methyl ketone |
| OLI0019 | allyl butyrate |
| OLI0020 | cinnamyl nitrile |
| OLI0024 | gamma-heptalactone |
| OLI0025 | methanethiol acetate |
| OLI0026 | methyl crotonate |
| OLI0027 | methyl levulinate |
| OLI0028 | phenylacetaldehyde |
| OLI0029 | phenyl propyl aldehyde |
| OLI0052 | Indole |
| OLI0059 | methyl heptadienone |
| OLI0065 | trans-cinnamaldehyde |
| OLI0066 | Valeraldehyde |
| OLI0067 | 2,3-diethyl-5-methylpyrazine |
| OLI0068 | 2,3-diethylpyrazine |
| OLI0069 | 2-ethyl-3-methylpyrazine |
| OLI0070 | 2-methoxy-3-methylpyrazine |
| OLI0071 | 2-ethyl-3-methoxypyrazine |
| OLI0072 | 2-methoxy-3(5or6) isopropylpyrazine |
| OLI0073 | cis-3-hexenyl acetate |
| OLI0074 | furfuryl pentanoate |
| OLI0075 | octanone-3 |
| OLI0076 | phenethyl propionate |
| OLI0077 | trans-2-decenal |
| OLI0079 | 1-ethylhexyl tiglate |
| OLI0084 | cis-5-octen-1-ol |
| OLI0091 | methyl heptanoate |
| OLI0092 | methyl amy ketone |
| OLI0096 | cis 3-hexenyl formate |
| OLI0097 | hexyl formate |
| OLI0100 | methyl (E)-hex-3-enoate |
| OLI0101 | peppermint oil |
| OLI0102 | Eugenol |
| OLI0104 | allyl cinnamate |
| OLI0105 | trans-cinnamyl propionate |
| OLI0106 | cinnamic aldehyde dimethyl acetal |
| OLI0107 | cinnamyl formate |
| OLI0109 | cinnamyl propionate |
| OLI0110 | ethyl cinnamate |
| OLI0111 | Menthalactone |
| OLI0112 | methoxy cinnamic aldehyde |
| OLI0113 | methyl cinnamate |
| OLI0114 | methyl trans-cinnamate |
| OLI0115 | Menthol |
| OLI0116 | Salicylaldehyde |
| OLI0117 | cinnamyl isobutyrate |
| OLI0118 | Ultrazur |
| OLI0119 | hexyl butyrate |

### Bed Bug Repellent and Attractant Compounds

In some embodiments, compounds, combinations and/or compositions of the present invention may be useful in the control of bed bug behavior. Bed bugs of the genus Cimex (including, but not limited to Cimex lectularius) are pests that bite humans (as well as other animals), feeding on blood. Bed bugs that feed on human blood often live in or around human sleeping areas, especially in warmer dwellings. Bites from bed bugs are associated with a number of adverse effects on health including, but not limited to rash development, allergic reactions and psychological effects. Some compounds and/or combinations of compounds of the present invention may be used to repel bed bugs from a given subject, region or habitat. Other compounds and/or combinations of compounds of the present invention may be used to attract bed bugs from a given subject, region or habitat.

### Compounds, Compositions and Combinations

According to the present invention, behavior modifying compounds useful as pest attractants and/or repellents have been identified. Many of these compounds can be categorized according to different structural and chemical properties. These categories include, but are not limited to aromatic compounds, pyrazine ring-containing compounds, furan ring-containing compounds, ketones, aldehydes, acetates, essential oils, environmentally safe compounds, flavoring agents and odorants.

Pyrazine compounds—compounds and compositions are disclosed herein containing components with one or more pyrazine ring structures. Pyrazine rings can be formed through the pyrolysis of natural amino acid precursors including serine and threonine in the presence of sugars such as glucose and fructose (Teranishi, R., Flavor Chemistry: Thirty Years of Progress, Springer, 1999). They are found in a variety of food items, especially those processed at elevated temperatures in the absence of water.

Furan compounds—compounds and compositions are disclosed herein containing components with one or more furan ring structures. Many of these compounds can be found in nature or are synthetic chemicals closely resembling those in nature. Furans themselves are cyclic and contain the formula C₄H₄O. They are often used as the starting point for chemical synthesis of other compounds.

Essential oils—compounds and compositions are disclosed herein that contain essential oils and/or compounds derived from essential oils. The term “essential oil” as used herein refers to any volatile aromatic liquid extracted from plants. Typically these compounds carry a distinctive scent of the plant from which they were extracted. Extraction is typically carried out by distillation allowing for extraction of concentrated compounds. Essential oils of the present invention include, but are not limited to rosemary oil, eucalyptol, peppermint oil and eugenol. Essential oils also include cinnamon oil, clove oil, mint oil, jasmine oil, geraniol, camphor oil, hinoki oil, sage oil, tohi oil, pomegranate oil, rose oil, turpentine oil, bergamot oil, mandarin oil, pine oil, calamus oil, lavender oil, bay oil, hiba oil, lemon oil, thyme oil, menthol, cineole, citral, citronella, linalool, borneol, camphor, thymol, spilanthole, pinene, terpene, limonene and the like. It is known in the art that some essential oils or combinations thereof, have repellent and/or attractant properties with regard to insects.

Eugenol (OLI0102) is a phenolic essential oil found at high levels in clove oil and is known to have strong antimicrobial and insecticidal activity. Interestingly, it can also act as an attractant for some insects, such as Japanese beetles. Its presence on the list of FIFRA exempt compounds makes it an attractive candidate for use in insecticides, repellents or lures.

Peppermint oil is extracted from the peppermint plant, a hybrid of watermint and spearmint. It is currently used in natural pesticides due to the presence of menthone, a known repellent agent.

Rosemary oil is extracted from the rosemary plant. It has a strong aroma and is a natural component of some pesticides.

Guaiacol is a natural compound and a component of wood-tar creosote. It is aromatic and has been used medicinally as an antipyretic, antiseptic and expectorant. In some embodiments, compounds and/or compositions of the present invention comprise guaiacol.

### Formulations

The compositions may be combined in formulations. As used herein, a “formulation” is a combination of one or more compounds or compositions prepared as per a formula and may include one or more excipients, carriers or delivery agents. Formulations may be dry or wet or may be solid or liquid. Formulations may be designed for one or more particular applications or uses. The formulations of the present invention are also compositions while compositions may be formulated.

Formulations of the compounds, compositions or combinations of the present invention may be deployed by aerosolization via sublimation, spray, vaporization, candle burning and the like. They may be deployed as solids such as blocks, rods, crystals, granules, pellets, beads, powders and the like for release of vapors over time. Said formulations may be designed for slow release.

In another embodiment, the compounds and compositions of the invention may be used in liquid form, either as purified liquids or in aqueous-based or non-aqueous (organic) formulations. As used herein the term “aqueous” means similar to or containing or dissolved in water, e.g., an aqueous solution. A “slurry” according to the present invention is a suspension of predominantly insoluble particles, usually in water. Suitable liquid diluents or carriers include water, petroleum distillates, or other liquid carriers. In one embodiment, said diluents further comprise surface active agents. Non-ionic, anionic, amphoteric, or cationic dispersing and emulsifying agents may be employed. The choice of liquid formulation components is dictated by the intended use of the composition, the desired distribution of the active compounds within the formulation and the ability of the formulation to be effectively spread across the desired treatment area. Said liquid formulations may be in the form of lotions, sprays, aerosols, foams, gels, balms, creams, mousse, patches (comprising such liquid formulations), suspensions, emulsions, microemulsions, emulsifiable concentrates, pump sprays, fragrances, perfumes, colognes, roll ons, solid sticks, gel sticks, towelettes, wipes, wet wipes, ointments, salves, pastes and the like.

In one embodiment, said odorant or liquid formulations may be used as a repellent to repel vector pests from a given area or from the vicinity of an individual or group of individuals.

In another embodiment, said odorant or liquid formulations may be activator formulations, employed to activate CO2-responsive neuronal activity. In further embodiments, said activator formulations are utilized as attractants to draw vector pests to a given site or away from a less desired site. The site of attraction may be a trap or device deployed to capture or otherwise attract the vector pests. Compounds or compositions of the invention may be formulated with attractants known in the art. These attractant formulations may comprise one or more of the following: sugar, honey, molasses, plant oils, animal oils such as fish oil and the like, plant extracts, floral odors, pheromones, proteins, salt, seeds, animal feed, livestock feed, sticky agents, adhesives including substances such as tanglewood and the like. In another embodiment, activator formulations may be utilized as a protectant to prevent vector pest attraction to an individual or group of individuals desired to be protected. These protectant formulations may act to overwhelm CO2-responsive neurons in vector pests, rendering them unable to track CO2 plumes exhaled from individuals or groups of individuals desired to be protected.

The compounds and compositions of the invention may be formulated for topical use on a given subject. In one embodiment, these topical formulations may be applied to a subject's skin. In a further embodiment the subjects may be non-human animals such as dogs, cats, horses, equines, bovines, pigs and others that exhale carbon dioxide and/or are vulnerable to vector pests. The compounds and compositions may also be formulated for application to materials such as an individual's clothing or apparel. Such materials may also include bedding, netting, bed netting, screens, curtains, walls, gear, equipment, patches, vehicles and the like.

### Other Components of Formulations

Formulations containing compounds or compositions of the present invention may comprise further components depending upon the desired use of the formulation. These components include, but are not limited to carriers, thickeners, surface-active agents, preservatives, aromatics, deodorizers, sunscreen active and one or more of several types of adjuvant including, but not limited to, wetting agents, spreading agents, sticking agents, foam retardants, buffers and acidifiers. As used herein, “sunscreen active” is an additive capable of absorbing or reflecting a portion of the solar ultraviolet radiation from a surface. In another embodiment, the compounds and compositions of the present invention may be supplied as a concentrate which may be diluted to achieve a desired strength depending on the application. The term “concentrate” as used herein, refers to a compound or composition in condensed form. A concentrate therefore may contain some diluents and not necessarily be purified.

### Carriers

The compounds and compositions of the present invention may contain one or more carriers or carrier vehicles. These carriers may be gaseous, liquid or solid and are most often inert but may be active ingredients. Carrier vehicles may include, but are not limited to, aerosol propellants, such as freon, (present in a gaseous state at normal temperatures and pressures); inert dispersible liquid diluent carriers, including inert organic solvents, aromatic hydrocarbons (such as benzene, toluene, xylene, alkyl naphthalenes, etc.), halogenated especially chlorinated, aromatic hydrocarbons (such as chloro-benzenes, etc.), chlorinated aliphatic hydrocarbons (such as chloroethylenes, methylene chloride, etc.), cycloalkanes, (such as cyclohexane, etc.), paraffins (such as petroleum or mineral oil fractions), acetonitrile, ketones (such as cyclohexanone, methyl ethyl ketone, acetone, methyl isobutyl ketone, etc.), alcohols (such as ethanol, methanol, propanol, glycol, butanol, etc.) as well as ethers and esters thereof (such as glycol monomethyl ether, etc.), amides (such as dimethylformamide etc.), amines (such as ethanolamine, etc.), sulfoxides (such as dimethylsulfoxide, etc.), and/or water. Carriers may also include inert, finely divided solid carriers that may be dispersible such as ground natural minerals (including, but not limited to chalk, i.e. calcium carbonate, silica, alumina, vermiculite, talc, kieselguhr, attapulgite, montmorillonite, etc.) as well as ground synthetic minerals (such as highly dispersed silicic acid, silicates, such as alkali silicates, etc.).

### Finely Divided Solid Carrier Formulations

The compounds and compositions of the present invention may be formulated for dispersion with finely divided solid carriers such as dust, talc, chalk, diatomaceous earth, vermiculite, sand, sulfur, flours, attapulgite clay, kieselguhr, pyrophyllite, calcium phosphates, calcium and magnesium carbonates, and other solids capable of acting as carriers. A typical finely divided solid formulation useful for modifying vector pest behavior contains 1 part compound or composition per 99 parts of said finely divided solid carrier. In one embodiment, these finely divided solids have an average particle size of about >50 microns. In another embodiment, said finely divided solids are granules. The term “granule,” as used herein refers to particles of a diameter of about 400-2500 microns. Said granules may comprise porous or nonporous particles. Finely divided solid carriers may be either impregnated or coated with the desired compound or composition. Granules generally contain 0.05-15%, preferably 0.5-5%, of the active compound or composition. Thus, the repellent compositions of the present invention can be formulated with any of the following solid carriers such as bentonite, fullers earth, ground natural minerals (such as kaolins, quartz, attapulgite, montmorillonite, etc.), ground synthetic minerals (such as highly-dispersed silicic acid, alumina and silicates), crushed and fractionated natural rocks (such as calcite, marble, pumice, sepiolite and dolomite), synthetic granules of inorganic and organic meals, and granules of organic materials (such as sawdust, coconut shells, corn cobs, tobacco stalks, walnut or other nut shells, egg shells and other natural cast off products that may or may not be a by-product of manufacturing or harvest).

### Surface-Active Agents

Formulations containing compounds and compositions of the present invention may include surface-active agents. “Surface-active agents” as referred to herein, are additives capable of lowering the surface tension of a liquid or between a liquid and a solid. Surface-active agents may include, but are not limited to emulsifying agents (such as non-ionic and/or anionic emulsifying agents, polyethylene oxide esters of fatty acids, polyethylene oxide ether of fatty alcohols, alkyl sulfates, alkyl sulfonates, aryl sulfonates, albumin hydrolyzates, alkyl arylpolyglycol ethers, magnesium stearate, sodium oleate, etc.) and/or dispersing agents (such as lignin, sulfite waste liquors, methyl cellulose, etc.)

### Thickeners

Formulations containing compounds or compositions of the present invention may contain one or more thickeners. The term “thickener”, as used herein refers to an additive that increases the viscosity of the formulation to which it is added without significantly modifying other properties of the formulation. They may also be used to impart a uniform consistency to the formulation. They are also useful for keeping components of a given formulation in suspension. Said thickeners include, but are not limited to agar, corn starch, guar gum and potato starch. Thickeners may be present at a concentration from about 0.1% to about 5% of the total composition.

### Preservatives

Formulations containing compounds or compositions of the present invention may contain one or more preservatives. The term “preservative”, as used herein refers to an additive capable of preventing decay, decomposition or spoilage in a composition. Said preservatives may be natural or synthetic; they may protect against a broad spectrum of spoilage or be targeted to one form (such as microbial, fungal or molding spoilage). Preservatives may include, but are not limited to calcium propionate, sodium nitrate, sodium nitrite, sulfur dioxide, sodium bisulfate, potassium hydrogen sulfite, disodium ethylenediaminetetraacetic acid (EDTA), formaldehyde, glutaraldehyde, ethanol, methylchloroisothiazolinone, potassium sorbate and the like. Other preservatives protect against chemical breakdown of compounds or compositions. Such preservatives include butylated hydroxyanisole (BHA) and butylated hydroxytoluene (BHT). Preservatives are typically present in formulations at a concentration from about 0.03% to about 3% by weight.

### Other Ingredients

The compounds and compositions of the invention may include “other ingredients” known to those skilled in the art and which may be added to formulations depending on the desired application. These include, but are not limited to milk, garlic, garlic powder, garlic oil, hot pepper, white pepper, oil of black pepper, piperine, chemically formulated pepper, clove, fish oil, optionally modified oil, onion, perfumes, bitrex, thiram, thymol, capsaicin, predator urines, urea, naphthalene (moth balls), pyrethrine, blood, blood meal, bone meal, sulfurous emitting items (eggs, sulfur, meats, etc), denatonium benzoate, formaldehyde, ammonia, methyl ammonium saccharide, ammonium of fatty acids, waxes, nutrients, butyl mercaptan, mineral oil, orange oil, kelp (seaweed), whole eggs, powdered eggs, putrescent eggs, egg whites, egg yolks, rotten eggs, rosemary, thyme, wintergreen, clay, 2-propenoic acid, potassium salt, 2-propeniamide, acetic acid, iron, manganese, boron, copper, cobalt, molybdenum, zinc, latex, animal glue and stickers like nufilm p and others in the series.

### Environmentally Safe Compounds

Formulations of compounds and compositions of the invention may contain environmentally safe compounds. As used herein, an “environmentally safe compound” is a compound that imposes reduced, limited, minimal and/or no harm to a given ecosystem or environment. Harmful chemicals are often used to control pests and biting insects. With increasing public awareness of the dangers posed by some chemicals to public health and to the environment, natural compounds have been increasingly explored as alternatives to synthetic and/or hazardous chemicals. To this end, the Environmental Protection Agency has taken legislative action to categorize certain natural compounds as safe, protecting the use of these environmentally safe compounds from certain government regulations. The Federal Insecticide, Fungicide and Rodenticide Act (FIFRA) outlines the exemptions as well as compounds covered by the act. In some embodiments, environmentally safe compounds include those identified as environmentally safe to use in pesticides by the Federal Insecticide, Fungicide and Rodenticide Act (FIFRA). Such compounds include, but are not limited to: (+)-butyl lactate; (+)-ethyl lactate; 1,2-propylene carbonate; 1-monolaurin; 1-monomyristin; 2-phenethyl propionate (2-phenylethyl propionate); acetyl tributyl citrate; agar; almond hulls; almond shells; alpha-cyclodextrin; aluminatesilicate; aluminum magnesium silicate; aluminum potassium sodium silicate; aluminum silicate; aluminum sodium silicate; aluminum sodium silicate (1:1:1); ammonium benzoate; ammonium stearate; amylopectin, acid-hydrolyzed, 1-octenylbutanedioate; amylopectin, hydrogen 1-octadecenylbutanedioate; animal glue; ascorbyl palmitate; attapulgite-type clay; beeswax; bentonite; bentonite, sodian; beta-cyclodextrin; bone meal; bran; bread crumbs; butyl lactate; butyl stearate; calcareous shale; calcite (Ca(Co₃)); calcium acetate; calcium acetate monohydrate; calcium benzoate; calcium carbonate; calcium citrate; calcium octanoate; calcium oxide silicate (Ca₃O(SiO₄)); calcium silicate; calcium stearate; calcium sulfate; calcium sulfate dihydrate; calcium sulfate hemihydrate; canary seed; carbon; carbon dioxide; carboxymethyl cellulose; cardboard; carnauba wax; carob gum; carrageenan; caseins; castor oil; castor oil, hydrogenated; cat food; cedar oil; cellulose; cellulose acetate; cellulose mixture (with cellulose carboxymethyl ether, sodium salt); cellulose, pulp; cellulose, regenerated; cheese; chlorophyll a; chlorophyll b; cinnamon and cinnamon oil; citric acid; citric acid, monohydrate; citronella and citronella oil; citrus meal; citrus pectin; citrus pulp; clam shells; cloves and clove oil; cocoa; cocoa shell flour; cocoa shells; cod-liver oil; coffee grounds; cookies; cork; corn cobs; corn gluten meal; corn oil; cotton; cottonseed meal; cottonseed oil; cracked wheat; decanoic acid, monoester with 1,2,3-propanetriol; dextrins; diatomaceous earth (less than 1% crystalline silica); diglyceryl monooleate; diglyceryl monostearate; dilaurin; dipalmitin; dipotassium citrate; disodium citrate; disodium sulfate decahydrate; dodecanoic acid, monoester with 1,2,3-propanetriol; dolomite; douglas fir bark; dried blood; egg shells; eggs; ethyl lactate; eugenol; feldspar; fish meal; fish oil (not conforming to 40 CFR 180.950); fuller's earth; fumaric acid; gamma-cyclodextrin; garlic and garlic oil; gelatins; gellan gum; geraniol; geranium oil; glue (as depolymd. animal collagen); glycerin; glycerol monooleate; glyceryl dicaprylate; glyceryl dimyristate; glyceryl dioleate; glyceryl distearate; glyceryl monomyristate; glyceryl monooctanoate; glyceryl monooleate; glyceryl monostearate; glyceryl stearate; granite; graphite; guar gum; gum arabic; gum tragacanth; gypsum; hematite (Fe₂O₃); humic acid; hydrogenated cottonseed oil; hydrogenated rapeseed oil; hydrogenated soybean oil; hydroxyethyl cellulose; hydroxypropyl cellulose; hydroxypropyl methyl cellulose; Iron magnesium oxide (Fe₂MgO₄); iron oxide (Fe₂O₃); iron oxide (Fe₂O₃), hydrate; iron oxide (Fe₃O₄); iron oxide (FeO); isopropyl alcohol; isopropyl myristate; kaolin; lactose; lactose monohydrate; lanolin; latex rubber; lauric acid; lauryl sulfate; lecithins; lemon grass oil; licorice extract; lime (chemical) dolomitic; limestone; linseed oil; magnesium benzoate; magnesium carbonate; magnesium oxide; magnesium oxide silicate (Mg₃O(Si₂O₅)₂), monohydrate; magnesium silicate; magnesium silicate hydrate; magnesium silicon oxide (Mg₂Si₃O₈); magnesium stearate; magnesium sulfate; magnesium sulfate heptahydrate; malic acid; malt extract; malt flavor; maltodextrin; methylcellulose; mica; mica-group minerals; milk; millet seed; mineral oil (U.S.P.); mint and mint oil; monomyristin; monopalmitin; monopotassium citrate; monosodium citrate; montmorillonite; myristic acid; nepheline syenite; nitrogen; nutria meat; nylon; octanoic acid, potassium salt; octanoic acid, sodium salt; oils, almond; oils, wheat; oleic acid; oyster shells; palm oil; palm oil, hydrogenated; palmitic acid; paper; paraffin wax; peanut butter; peanut shells; peanuts; peat moss; pectin; peppermint and peppermint oil; perlite; perlite, expanded; plaster of paris; polyethylene; polyglyceryl oleate; polyglyceryl stearate; potassium acetate; potassium aluminum silicate, anhydrous; potassium benzoate; potassium bicarbonate; potassium chloride; potassium citrate; potassium humate; potassium myristate; potassium oleate; potassium ricinoleate; potassium sorbate; potassium stearate; potassium sulfate; potassium sulfate; pumice; putrescent whole egg solids; red cabbage color (expressed from edible red cabbage heads via a pressing process using only acidified water); red cedar chips; red dog flour; rosemary and rosemary oil; rubber; sawdust; sesame (includes ground sesame plant stalks) and sesame oil; shale; silica (crystalline free); silica gel; silica gel, precipitated, crystalline-free; silica, amorphous, fumed (crystalline free); silica, amorphous, precipated and gel; silica, hydrate; silica, vitreous; silicic acid (H₂SiO₃), magnesium salt (1:1); soap (the water soluble sodium or potassium salts of fatty acids produced by either the saponification of fats and oils, or the neutralization of fatty acid); soapbark (Quillaja saponin); soapstone; sodium acetate; sodium alginate; sodium benzoate; sodium bicarbonate; sodium carboxymethyl cellulose; sodium chloride; sodium citrate; sodium humate; sodium lauryl sulfate; sodium oleate; sodium ricinoleate; sodium stearate; sodium sulfate; sorbitol; soy protein; soya lecithins; soybean hulls; soybean meal; soybean oil; soybean, flour; stearic acid; sulfur; syrups, hydrolyzed starch, hydrogenated; tetragylceryl monooleate; thyme and thyme oil; tricalcium citrate; triethyl citrate; tripotassium citrate; tripotassium citrate monohydrate; trisodium citrate; trisodium citrate dehydrate; trisodium citrate pentahydrate; ultramarine blue; urea; vanillin; vermiculite; vinegar (maximum 8% acetic acid in solution); Vitamin C; Vitamin E; walnut flour; walnut shells; wheat; wheat flour; wheat germ oil; whey; white mineral oil (petroleum); white pepper; wintergreen oil; wollastonite (Ca(SiO₃)); wool; xanthan gum; yeast; Zeolites (excluding erionite (CAS Reg. No. 66733-21-9)); Zeolites, NaA; zinc iron oxide; zinc metal strips (consisting solely of zinc metal and impurities); zinc oxide (ZnO) and zinc stearate.

### Other Aromatics

Formulations of compounds and compositions of the invention may contain other aromatic compounds or compositions. The term “aromatic” as used herein refers to a compound having a distinctive smell or aroma. Such compounds are typically volatile allowing for rapid diffusion into the surrounding air and easily sensed within the olfactory system. One such aromatic compound is cedar oil. Cedar oil may be useful in a given formulation for its ability to both repel insects as well as to kill larval mosquitoes present in a body of water. Cedar oil formulations may contain from about 0.01% to about 10%, from about 1% to about 5%, from about 2% to about 20% or from about 5% to about 50% cedar oil by weight percent.

Other aromatics that may be included in formulations of compounds and compositions of the invention include, but are not limited to camphor, pyrethrin and permethrin. Such formulations may contain from about 0.01% to about 10%, from about 1% to about 5%, from about 2% to about 20% or from about 5% to about 50% camphor, pyrethrin and/or permethrin by weight percent.

### Adjuvants

Formulations of compounds and compositions of the invention may comprise adjuvants. The term “adjuvant”, as used herein refers to any substance that improves or enhances one or more properties of another component within the formulation. Said adjuvants may include, but are not limited to buffers, acidifiers, wetting agents, spreading agents, sticking agents, adhesives, colorants, stabilizers, waterproofing agents, foam retardants and the like.

Formulations with Other Known Agents

Formulations comprising compounds and compositions of the invention may combine said compounds and compositions with other compatible active agents known in the art including pesticides, insecticides, bactericides, fungicides, acaricides, microbicides, rodenticides, nematocides, herbicides and the like. The term “bactericide” refers to substances which may destroy or blocking the growth of bacteria; “fungicide” refers to substances which may destroy or block the growth of fungi; “acaricide” refers to substances which may destroy or block the growth of members of the Arachnida subclass, Acari; “microbicide” refers to substances which may kill or block the growth of microorganisms; “rodenticide” refers to chemical substances which may be capable of destroying rodents; “nematocide” refers to chemical substances which may be capable of destroying or blocking the growth of nematodes; “herbicide” refers to chemical substances which may be capable of destroying or blocking the growth of plant life.

### Concentrations and Combinations

The compounds and compositions of the invention may be produced or formulated in various concentrations depending upon the desired application, vector pest, desired effect on neuronal activity and depending upon the type of surface or area that the invention will be applied to.

Typically active components within a given composition will be present in the composition in a concentration of at least about 0.0001% by weight. In another embodiment, active components may be present at a concentration from about 0.001% to about 0.01%, from about 0.001% to about 0.02%, from about 0.001% to about 0.03%, from about 0.001% to about 0.04%, from about 0.001% to about 0.05%, from about 0.001% to about 0.06%, from about 0.001% to about 0.07%, from about 0.001% to about 0.08%, from about 0.001% to about 0.09%, from about 0.001% to about 0.10%, from about 0.001% to about 0.11%, from about 0.001% to about 0.12%, from about 0.001% to about 0.13%, from about 0.001% to about 0.14%, from about 0.001% to about 0.15%, from about 0.001% to about 0.16%, from about 0.001% to about 0.17%, from about 0.001% to about 0.18%, from about 0.001% to about 0.19%, from about 0.001% to about 0.20%, from about 0.001% to about 0.21%, from about 0.001% to about 0.22%, from about 0.001% to about 0.23%, from about 0.001% to about 0.24%, from about 0.001% to about 0.25%, from about 0.001% to about 0.26%, from about 0.001% to about 0.27%, from about 0.001% to about 0.28%, from about 0.001% to about 0.29%, from about 0.001% to about 0.30%, from about 0.001% to about 0.31%, from about 0.001% to about 0.32%, from about 0.001% to about 0.33%, from about 0.001% to about 0.34%, from about 0.001% to about 0.35%, from about 0.001% to about 0.36%, from about 0.001% to about 0.37%, from about 0.001% to about 0.38%, from about 0.001% to about 0.39%, from about 0.001% to about 0.40%, from about 0.001% to about 0.41%, from about 0.001% to about 0.42%, from about 0.001% to about 0.43%, from about 0.001% to about 0.44%, from about 0.001% to about 0.45%, from about 0.001% to about 0.46%, from about 0.001% to about 0.47%, from about 0.001% to about 0.48%, from about 0.001% to about 0.49%, from about 0.001% to about 0.50%, from about 0.1% to about 1.0%, from about 0.1% to about 1.5%, from about 0.1% to about 2.0%, from about 0.1% to about 2.5%, from about 0.1% to about 3.0%, from about 0.1% to about 3.5%, from about 0.1% to about 4.0%, from about 0.1% to about 4.5%, from about 0.1% to about 5.0%, from about 0.1% to about 5.5%, from about 0.1% to about 6.0%, from about 0.1% to about 6.5%, from about 0.1% to about 7.0%, from about 0.1% to about 7.5%, from about 0.1% to about 8.0%, from about 0.1% to about 8.5%, from about 0.1% to about 9.0%, from about 0.1% to about 9.5%, from about 0.1% to about 10.0%, from about 0.1% to about 10.5%, from about 0.1% to about 11.0%, from about 0.1% to about 11.5%, from about 0.1% to about 12.0%, from about 0.1% to about 12.5%, from about 0.1% to about 13.0%, from about 0.1% to about 13.5%, from about 0.1% to about 14.0%, from about 0.1% to about 14.5%, from about 0.1% to about 15.0%, from about 0.1% to about 15.5%, from about 0.1% to about 16.0%, from about 0.1% to about 16.5%, from about 0.1% to about 17.0%, from about 0.1% to about 17.5%, from about 0.1% to about 18.0%, from about 0.1% to about 18.5%, from about 0.1% to about 19.0%, from about 0.1% to about 19.5%, from about 0.1% to about 20.0%, from about 1% to about 5%, from about 1% to about 10%, from about 1% to about 15%, from about 1% to about 20%, from about 1% to about 25%, from about 1% to about 30%, from about 1% to about 35%, from about 1% to about 40%, from about 1% to about 45%, from about 1% to about 50%, from about 1% to about 55%, from about 1% to about 60%, from about 1% to about 65%, from about 1% to about 70%, from about 1% to about 75%, from about 1% to about 80%, from about 1% to about 85%, from about 1% to about 90%, from about 1% to about 95%, from about 1% to about 100%, from about 10% to about 20%, from about 10% to about 30%, from about 10% to about 40%, from about 10% to about 50%, from about 10% to about 60%, from about 10% to about 70%, from about 10% to about 80%, from about 10% to about 90%, or from about 10% to about 100% by weight. Additionally, compounds may be combined in various embodiments such that compositions and formulations of the present invention contain 2, 3, 4, 5, 6, 7, 8, 9, 10, 11, 12, 13, 14, 15, 16, 17, 18, 19, 20 or more active compounds or compositions.

Units of measure used herein embrace standard units as well as metric units. It is to be understood that where compounds or compositions are measured, formulated or packaged in liquid form, the units may be in increments of ounces, cups, pints, quarts, gallons, barrels, or portions thereof. They may also be in metric increments of milliliters, cubic centimeters, deciliters, liters, cubic meters or portions thereof.

It is to be understood that where compounds and compositions are measured, formulated or packaged as solids, the units may have increments of ounces, pounds, tons, or portions thereof. They may also comprise increments of milligrams, grams, kilograms, metric tons or portions thereof.

Coverage, as it relates to the effective surface or area where vector pest behavior may be modified in response to application of a compound or composition of the invention, may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof.

### Methods of Application or Treatment

Compounds and compositions of the invention may be used to modify pest (e.g., vector pest) behavior in a given area or within the vicinity of an individual or structure. Human and non-human animal subjects may benefit from such use. As used herein, the term “subject” refers to any organism, human or non-human. Non-human animals may include, but are not limited to dogs, cats, mice, rats, rabbits, horses, cattle, sheep, goats, pigs, rodents, chickens, etc.

Many methods of application are known in the art that would be convenient for applying compounds or compositions of the present invention to a desired object, individual, surface, area or region. Such methods include, but are not limited to aerosolizing, dusting, vaporizing, misting, spraying, spreading, broadcasting, spackling, sprinkling, painting, brushing, coating, rolling, banding, side-dressing, mopping, bathing, soaking, dipping, immersing, sticking, adhering, wiping, rubbing, impregnating, embedding, injecting, sealing, dotting, dabbing, stippling, layering, stenciling, stamping, pouring and the like. In some embodiments, pests are exposed to compounds and/or compositions of the present invention on or around the surface of a wick that draws from a solution comprising compounds and/or compositions of the present invention.

Methods of application may rely on indirect methods of dispersion. In one embodiment, the compound or composition may be left in an area where it may be dispersed by active forces of nature such as wind, rain, sunlight, water current and the like. In another embodiment, a mechanical device may be used to effect the applications listed herein. In a further embodiment, said mechanical device is a timed spreaders or broadcasters, set up in predetermined areas in order to apply or disperse the compound or composition to a surface, area or substrate in a temporal fashion. Said mechanical devices may be automated or initiated remotely to apply compounds or compositions of the invention.

### Assays and Testing

Compounds and/or compositions of the present invention may be developed in conjunction with assays and/or testing to determine the effectiveness of such compounds and/or compositions or derivatives thereof. In some embodiments, testing is carried out to determine the effect of compounds and/or compositions of the present invention on pest behavior. Such testing may be used to determine the ability of compounds and/or compositions of the present invention to act as attractants or repellents.

In some embodiments, spatial experiments are carried out to determine the effect of compounds and/or compositions of the present invention on pest behavior (e.g. mosquito behavior). Such spatial experiments comprise the use of one or more spatial arenas. As used herein, the term “spatial arena” refers to any enclosed space. Such arenas may range in size from 1 ft³ to large arenas (including but not limited to semi-field chambers) of about 10,000 ft³. Materials used to enclose spatial arenas may vary depending upon the desired application. Materials may comprise one or more of plastic sheets, cloth, glass, netting, wood, sheetrock, fiberglass, screening, metal and the like. Spatial arenas may also be climate controlled. In such arenas, one or more of heat, light, humidity and air circulation may be controlled to limit experimental variation and/or simulate a given environment. Pest behaviors that may be observed during spatial experiments include, but are not limited to movement toward or away from a given agent, changes in pest movement level, immobilization, erratic movements and/or death.

In some embodiments, field testing is carried out to test compounds and/or compositions of the present invention. As used herein, the term “field testing” refers to testing done in one or more natural environments. Field testing may use traps to collect pests and/or record pest numbers at, in or around trap sites. As used herein, the term “trap” refers to any device and/or object used for attracting, capturing and/or killing one or more pests. Traps may be natural or man-made. In some embodiments, traps of the present invention may be passive traps. As used herein, the term “passive trap” refers to a stationary trap that relies on the movement of pests to the trap vicinity. Such traps include those described by Ritchie et al (Ritchie, S. A. et al., A simple non-powered passive trap for the collection of mosquitoes for Arbovirus surveillance. Journal of Medical Entomology. 2013. 50(1):185-94). In some embodiments, passive traps may not have moving mechanisms, relying on stationary trap components to immobilize pests and/or prevent their escape from the trap area. In some embodiments, traps may comprise a container (such as a box, cylinder, etc) for collecting pests attracted to the trap. In some embodiments, traps may comprise a lure or bait for attracting pests to the trap. Such lures may include compounds and/or compositions provided herein.

In some embodiments, traps may be lethal traps. As used herein, the term “lethal trap” refers to a trap that kills one or more pests captured by such a trap. Such traps may comprise one or more toxic compounds that may be lethal upon exposure to one or more pests (e.g. ingestion, inhalation, etc). In some embodiments, lethal traps kill captured pests by immobilization (e.g. restriction from movement and/or nutritional sources necessary for vitality).

### Kits and Devices

The compounds, compositions and combinations of the present invention may be combined with other ingredients or reagents or prepared as components of kits or other retail products for commercial sale or distribution. These kits and or formulations may be sold to retailers for the purpose of selling these retail products for public use according to the methods disclosed herein. As such the present invention embraces methods of manufacturing or production of kits and or products to be provided to an end-user. Kits may contain packaging, a vial or container comprising the compounds, compositions or combinations and optionally instructions for use.

Compounds, compositions and apparatuses of the present invention may be sold in modular form for assembly, dilution or other method of reconstruction by a subsequent individual or end user as a kit. Said kits may be provided complete with all necessary components to assemble the active composition, formulation or apparatus. In another embodiment, said kits provide a partial number of components necessary and require that the subsequent user or end user provide one or more components separately (such as water or other solvent for dilution, rehydration, etc.)

In some embodiments, compounds and/or compositions of the present invention may be used in conjunction with devices to house, contain and/or facilitate diffusion of such compounds and/or compositions. Such devices may include decorative stands, balls, sticks (such sticks comprising of materials that may include, but are not limited to cellulose, plastic, wood, paper and the like), coils, paints, fabrics, patches, cattle/animal ear tags, bed nets, infused plastics, foggers, candles, lanterns, lamps, clip-on devices and plug-in devices (with or without air diffusers.) Such devices may comprise compounds and/or compositions of the present invention in liquid and/or solid state forms. In some embodiments, such devices may be capable of being refilled.

### Patches

In some embodiments, formulations comprising compounds of the present invention may be applied to or incorporated within a patch. As used herein, the term “patch” refers to a small piece of material. Patches may act as matrices that hold compounds and/or compositions of the present invention. Patches that have been applied with or infused with formulations of the present invention may be used to modify the behavior of vector pests that come within a given vicinity of such patches, in some embodiments, acting as a spatial repellent. Compounds and/or compositions of the present invention may be applied to patches in liquid format or formulation. In some cases, patches are used while such liquid formulations are still wet, while in other embodiments, liquid formulations are allowed to dry. Patches of the present invention may comprise any of a number of materials including, but not limited to paper, plastic, metal, fabric, wax, polymeric materials, polyethylene, polypropylene, rubber, cellulose, silicon rubber and/or cellulose-based materials. Some patches are designed to be water-resistant or water-proof.

Patches may be of various sizes and shapes. In some embodiments, patches are flat and comprise an area of from about 1 cm² to about 5 cm², from about 2 cm² to about 10 cm², from about 3 cm² to about 15 cm², from about 4 cm² to about 20 cm², from about 12 cm² to about 48 cm², from about 24 cm² to about 72 cm², from about 50 cm² to about 100 cm² or at least 100 cm². Patch shapes may include, but are not limited to circles, squares, rectangles, triangles and polygons. In some embodiments, patches are square with side lengths of about 1.5 cm. Additionally, patches may comprise any color and or pattern. Non-limiting examples of patch colors include red, orange, yellow green, blue, purple, indigo, violet, black, white, fluorescent, etc. Non-limiting examples of patch patterns include striped, checkerboard patterned, spotted, dotted, speckled, camouflaged, etc.

Patches may be applied to subjects according to any methods known to those of skill in the art. Such methods may include, but are not limited to direct application to subject skin, clothing or apparel (e.g. accessory items, hats, backpacks, scarfs, gloves, shoes, sunglasses, ear rings, etc.) Patches may be associated with such skin, clothing or apparel through adhesives (e.g. glues, pastes, gels, resins, gums, epoxies, etc.), static electrical interactions, tape, banding (such as attachment using a wrist, leg and/or waste band) or through other methods known in the art. Some adhesives that may be used may be water-resistant or water-proof adhesives. Some patches comprise a film or paper layer to protect patch adhesives. Such film or paper layers may be peeled off prior to application of such patches.

In some embodiments, patches may be placed inside or attached to a holder. As used herein, the term “holder” refers to a container or device used to house and/or grasp a patch. Holders may comprise pockets, compartments, cassettes, boxes, clips or other such devices that may be used to house or bind a patch. Some holders may comprise materials including, but not limited to metal, plastic, elastic, mesh, screen, fabric and/or wood. Holders may vary in size to accommodate home or outdoor uses.

Some patches and/or holders may be attached to subjects using accessory devices. As used herein, the term “accessory device” refers to a device of secondary importance in relation to a first device. In some embodiments, accessory devices may comprise something that is worn to attach patches and/or holders to a subject. Such accessory devices may include, but are not limited to bracelets, necklaces, wrist bands, collars, arm bands, clothing, fabric and/or clip-on devices. In some embodiments accessory devices may comprise air diffusers. As used herein, the term “air diffuser” refers to a device that circulates air, allowing for the spreading and/or dissipation of aerosols. Such air diffusers may be powered (e.g. battery powered, solar powered, etc.) or un-powered. Some air diffusers may comprise a fan. Air diffusers may be used to disperse compounds and/or compositions comprised in patches, creating a greater zone of protection.

In some embodiments, patches may be used to protect non-human animal subjects, including, but not limited to cats, pigs, dogs, horses and cattle. Patches may be associated with such animals through an accessory device, non-limiting examples of which may include collars or bands. In other embodiments, patches are placed within a holder that is worn around the neck or other body part of such animals.

### Traps

In some embodiments, compounds and/or compositions of the present invention may be used as part of a trap. In some embodiments, compounds and/or compositions of the present invention may be used as attractants and/or in combination with other attractants to lure pests to a trap. In some embodiments, compounds and/or compositions of the present invention may be used as biocides to control insects that may be overcrowding a trap and/or a bait or lure present in, on or around a trap.

### EQUIVALENTS AND SCOPE

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

Where the term “about” is used, it is understood to reflect +/−10% of the recited value.

In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the invention (e.g., any nucleic acid or protein encoded thereby; any method of production; any method of use; etc.) can be excluded from any one or more claims, for any reason, whether or not related to the existence of prior art.

All cited sources, for example, references, publications, databases, database entries, and art cited herein, are incorporated into this application by reference, even if not expressly stated in the citation. In case of conflicting statements of a cited source and the instant application, the statement in the instant application shall control.

Section and table headings are not intended to be limiting.

### Examples

### Example 1

### Identification of Sensory Neuron Modulators-Activators

Carbon dioxide receptor neurons in mosquitoes are responsible for sensing and responding to carbon dioxide levels. In the mosquito species, Aedes aegypti, cpA neurons of the maxillary palp are the primary CO2 sensors while cpB and cpC neurons, whose activity can be visualized at the same time as the cpA neuron, are also responsive to skin odors (Lu, T. et al., Odor coding in the maxillary palp of the malaria vector mosquito Anopheles gambiae. Curr Biol. 2007 Sep. 18; 17(18):1533-44. Epub 2007 Aug. 30).

In an effort to identify compounds having an effect on sensory neurons, extracellular single-sensillum electrophysiology, as described in Dobritsa et al., 2003 (Dobritsa, A. A. et al., Integrating the molecular and cellular basis of odor coding in the Drosophila antenna. Neuron. 2003 Mar. 6; 37(5):827-41) and modified by Turner et al., 2011 (Turner, S. L. et al., Ultra-prolonged activation of CO2-sensing neurons disorients mosquitoes. Nature. 2011 Jun. 2; 474(7349):87-91), was performed to test the response of cpA neurons to various compounds and compositions. To this end, various compounds and compositions were tested for their ability to stimulate mosquito neuronal activity in CO2-responsive neurons. Mosquitoes were immobilized and placed in line with a stream of air from an odor-delivery system. In this system a steady flow of humidified air was maintained with a controlled, minimal level of CO2 gas. The humidified airstream was delivered at 10 ml/sec from a purified air tank. CO2 gas was provided through a separate system capable of delivering controlled pulses (2.5 ml/sec-6.5 ml/sec) to the humidified airstream. Levels of CO2 were manipulated by switching between 1%, and 100% CO2 compressed air sources. Additionally, the odor-delivery system was designed to deliver a controlled level of air containing vapors from a desired chemical or chemical composition.

In order to test the cpA neuronal response to various chemical stimuli, highly purified chemicals or chemical compositions were diluted in a test solution comprising paraffin oil and applied to a cartridge comprising a Pasteur pipette with a cotton wool insert for receiving the solution as described by Turner et al., 2009 (Turner, S. L. et al., Modification of CO2 avoidance behaviour in Drosophila by inhibitory odorants. Nature. 2009 Sep. 10; 461(7261):277-81. Epub 2009 Aug. 26). Air was puffed through the odor cartridge at a controlled volume (5 ml/sec) for each puff, delivering vapors to the constant humidified airstream flowing over the mosquito.

To detect neuronal response, extracellular single-sensillum electrophysiology was performed as described in Dobritsa et al., 2003 (Dobritsa, A. A. et al., Integrating the molecular and cellular basis of odor coding in the Drosophila antenna. Neuron. 2003 Mar. 6; 37(5):827-41) and modified as described in Turner et al., 2011 (Turner, S. L. et al., Ultra prolonged activation of CO₂-sensing neurons disorients mosquitoes. Nature. 2011 Jun. 2; 474(7349):87-91).

Following this method, neuronal action potential was detected and recorded by inserting an electrode through the wall of the sensillum and into contact with the lymph associated with the dendritic cells therein. The recording electrode was comprised of a glass capillary with a tip drawn to a diameter of <1 micrometer. The capillary was filled with sensillum lymph ringer solution (0.4% glucose, 1.3% KCl, 0.1% KH₂PO₄, 0.2% K₂HPO₄, 0.06% MgCl₂, 0.01% CaCl₂ and 0.0001% HCl, pH 6.5) and placed over an AgCl-coated silver wire. A second, indifferent electrode, was also filled with sensillum lymph ringer solution and put into the eye of the mosquito. The impulse signals obtained were amplified and filtered to analyze only the traces in which the neuronal activity of the different neurons in the sensillum were isolated by impulse amplitude.

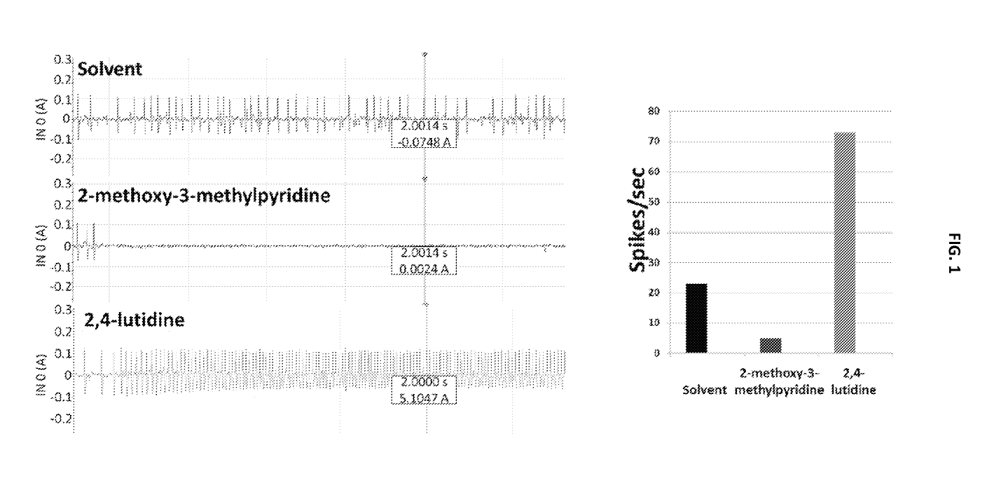

The number of impulses, referred to herein as “spikes” per second (spk/sec) were recorded as an indicator of neuronal activity in response to the stimulus provided. The final activation values were obtained by subtracting the levels recorded upon stimulation from the baseline activity values. As an example of results obtained using this method, FIG. 1 illustrates the basal activity of the CO2-receptor with paraffin oil, the solvent for the chemicals tested using electrophysiology (top panel), compared to 1% concentrations of an inhibitor, 2-methoxy-3-methylpyridine (middle panel), and an activator, 2,4-lutidine (bottom panel). 2-methoxy-3-methylpyridine is approved for fragrance use and has a “nutty” odor. 2,4-lutidine has a “green” odor, is approved for cosmetic fragrance use and is listed by the Flavor and Extract Manufacturers Association (FEMA) as a “Generally Regarded as Safe” (GRAS) compound.

### Example 2

### Identification of Activator Compounds

Following the experimentals outlined in Example 1, a series of compounds were tested for their ability to activate cpA neuronal activity. A list of these compounds is provided in Table 6. The compounds are categorized according to their strength as activators where strong activators yield an increase in activity that is >60 spk/sec over baseline neuronal activity. Moderate activators yield an increase in neuronal activity that is between 40 and 60 spk/sec over baseline neuronal activity. Finally, mild activators yield an increase in neuronal activity that is between 20 and 40 spk/sec over baseline neuronal activity.

TABLE 6
Activator Compounds

| Compound | | |
|---|---|---|
| No. | Compound | Class |
| OLI0001 | 2,4-lutidine | Strong Activator |
| OLI0002 | 2-ethylpyrazine | Strong Activator |
| OLI0003 | 2-methoxypyrazine | Strong Activator |
| OLI0004 | 2-methyltetrahydrofuran-3-one | Strong Activator |
| OLI0005 | 4-ethylphenol | Strong Activator |
| OLI0006 | 5-methyl furfural | Strong Activator |
| OLI0007 | butyl formate | Strong Activator |
| OLI0008 | Cyclopentanone | Strong Activator |
| OLI0009 | ethyl 2-furoate | Strong Activator |
| OLI0010 | Ethyllactate | Strong Activator |
| OLI0011 | Ethylvinylcarbinol | Strong Activator |
| OLI0012 | Guaiacol | Strong Activator |
| OLI0013 | trans-2-methyl-2-butenal | Strong Activator |
| OLI0014 | 2,3,5-trimethylpyrazine | Moderate Activator |
| OLI0015 | 2,3-dimethylpyrazine | Moderate Activator |
| OLI0016 | 2-acetyl-5-methyl furan | Moderate Activator |
| OLI0017 | 2-furyl methyl ketone | Moderate Activator |
| OLI0018 | 2-pentanone | Moderate Activator |
| OLI0019 | allyl butyrate | Moderate Activator |
| OLI0020 | cinnamyl nitrile | Moderate Activator |
| OLI0021 | ethyl 3-hydroxyhexanoate | Moderate Activator |
| OLI0022 | Ethylacetoacetate | Moderate Activator |
| OLI0023 | Ethylvinylketone | Moderate Activator |
| OLI0024 | gamma-heptalactone | Moderate Activator |
| OLI0025 | methanethiol acetate | Moderate Activator |
| OLI0026 | methyl crotonate | Moderate Activator |
| OLI0027 | methyl levulinate | Moderate Activator |
| OLI0028 | Phenylacetaldehyde | Moderate Activator |
| OLI0029 | Phenylpropylaldehyde | Moderate Activator |
| OLI0030 | 2,4-dimethyl benzaldehyde | Mild Activator |
| OLI0031 | 2,4-dimethyl-3-cyclohexene- | Mild Activator |
| | carboxaldehyde (mixture of | |
| | cis/transforms) | |
| OLI0032 | 2-ethyl-5(6)-methylpyrazine | Mild Activator |
| OLI0033 | 2-methoxy-4-methylphenol | Mild Activator |
| OLI0034 | 2-phenylpropionaldehyde | Mild Activator |
| OLI0035 | 3-hexanone | Mild Activator |
| OLI0036 | 4-ethylbenzaldehyde | Mild Activator |
| OLI0037 | 4-oxoisophorone | Mild Activator |
| OLI0038 | acetyl-2-pyrazine | Mild Activator |
| OLI0039 | butan-3-one-2yl butanoate | Mild Activator |
| OLI0040 | dimethyl succinate | Mild Activator |
| OLI0041 | dipropylenglykol-monomethyl ether | Mild Activator |
| OLI0042 | ethyl 3-hydroxybutyrate | Mild Activator |
| OLI0043 | ethyl-2,3,5(6)-dimethyl pyrazine | Mild Activator |
| OLI0044 | Ethylformate | Mild Activator |
| OLI0045 | Ethylisobutyrate | Mild Activator |
| OLI0046 | Ethylisovalerate | Mild Activator |
| OLI0047 | Ethyllevulinate | Mild Activator |
| OLI0048 | Furfurylethylether | Mild Activator |
| OLI0049 | Heptaldehyde | Mild Activator |
| OLI0050 | heptanone-4 | Mild Activator |
| OLI0051 | Hexanal | Mild Activator |
| OLI0052 | Indole | Mild Activator |
| OLI0053 | isobutyl acetate | Mild Activator |
| OLI0054 | isobutyl propionate | Mild Activator |
| OLI0055 | isobutyl trans-2-butenoate | Mild Activator |
| OLI0056 | isopropyl butyrate | Mild Activator |
| OLI0057 | isopropyl tiglate | Mild Activator |
| OLI0058 | methyl isovalerate | Mild Activator |
| OLI0059 | Methylheptadienone | Mild Activator |
| OLI0060 | m-tolualdehyde | Mild Activator |
| OLI0061 | o-anisaldehyde | Mild Activator |
| OLI0062 | Prenylacetate | Mild Activator |
| OLI0063 | propyl formate | Mild Activator |
| OLI0064 | R-+ pulegone | Mild Activator |
| OLI0065 | trans-cinnamaldehyde | Mild Activator |
| OLI0066 | Valeraldehyde | Mild Activator |

### Example 3

### Identification of Very Strong Activator Combinations

Following the experimentals outlined in Example 1, a series of combinations were tested for their ability to activate cpA neuronal activity. Table 7 shows neuronal activity values (spk/sec) obtained after introducing a variety of combinations into the odor-delivery system. Combinations tested were composed of 1% of component A and 1% component B in the test solution. Each of these combinations led to neuronal activity values above 100 spk/sec. As such, these combinations are considered very strong activators. In many instances, the combination of two components or compounds produced activity which was greater than the activity of either compound alone. In this case, the combination was considered synergistic. In the Table, “Act” refers to activity and “Cmpd” refers to compound.

TABLE 7
Very Strong Activator Combinations

| | | | | Act |
|---|---|---|---|---|
| Cmpd | | Cmpd | | (spk/ |
| No. | Component A | No. | Component B | sec) |
| OLI0006 | 5-methylfurfural | OLI0001 | 2,4-lutidine | 110 |
| OLI0006 | 5-methylfurfural | OLI0002 | 2-ethylpyrazine | 119 |
| OLI0006 | 5-methylfurfural | OLI0003 | 2-methoxypyrazine | 113 |
| OLI0006 | 5-methylfurfural | OLI0004 | 2- | 124 |
| | | | methyltetrahydrofuran- | |
| | | | 3-one | |
| OLI0006 | 5-methylfurfural | OLI0007 | butylformate | 101 |
| OLI0006 | 5-methylfurfural | OLI0008 | cyclopentanone | 143 |
| OLI0006 | 5-methylfurfural | OLI0010 | ethyllactate | 159 |
| OLI0006 | 5-methylfurfural | OLI0011 | ethylvinylcarbinol | 135 |
| OLI0017 | 2- | OLI0020 | cinnamylnitrile | 115 |
| | furylmethylketone | | | |
| OLI0017 | 2- | OLI0022 | ethylacetoacetate | 112 |
| | furylmethylketone | | | |
| OLI0008 | cyclopentanone | OLI0001 | 2,4-lutidine | 136 |
| OLI0008 | cyclopentanone | OLI0002 | 2-ethylpyrazine | 156 |
| OLI0008 | cyclopentanone | OLI0003 | 2-methoxypyrazine | 156 |
| OLI0008 | cyclopentanone | OLI0004 | 2- | 151 |
| | | | methyltetrahydrofuran- | |
| | | | 3-one | |
| OLI0008 | cyclopentanone | OLI0022 | ethylacetoacetate | 151 |
| OLI0008 | cyclopentanone | OLI0011 | ethylvinylcarbinol | 144 |
| OLI0010 | Ethyllactate | OLI0001 | 2,4-lutidine | 162 |
| OLI0010 | Ethyllactate | OLI0002 | 2-ethylpyrazine | 154 |
| OLI0010 | Ethyllactate | OLI0003 | 2-methoxypyrazine | 167 |
| OLI0010 | Ethyllactate | OLI0004 | 2- | 164 |
| | | | methyltetrahydrofuran- | |
| | | | 3-one | |
| OLI0010 | Ethyllactate | OLI0007 | butylformate | 110 |
| OLI0010 | Ethyllactate | OLI0008 | cyclopentanone | 163 |
| OLI0010 | Ethyllactate | OLI0011 | ethylvinylcarbinol | 156 |
| OLI0010 | Ethyllactate | OLI0013 | trans-2-methyl- | 126 |
| | | | 2-butenal | |
| OLI0007 | Butylformate | OLI0001 | 2,4-lutidine | 119 |
| OLI0007 | Butylformate | OLI0002 | 2-ethylpyrazine | 118 |
| OLI0007 | Butylformate | OLI0003 | 2-methoxypyrazine | 108 |
| OLI0007 | Butylformate | OLI0004 | 2- | 131 |
| | | | methyltetrahydrofuran- | |
| | | | 3-one | |
| OLI0007 | Butylformate | OLI0008 | cyclopentanone | 146 |
| OLI0007 | Butylformate | OLI0011 | ethylvinylcarbinol | 110 |
| OLI0013 | trans-2-methyl-2- | OLI0001 | 2,4-lutidine | 112 |
| | butenal | | | |
| OLI0013 | trans-2-methyl-2- | OLI0002 | 2-ethylpyrazine | 127 |
| | butenal | | | |
| OLI0013 | trans-2-methyl-2- | OLI0003 | 2-methoxypyrazine | 126 |
| | butenal | | | |
| OLI0013 | trans-2-methyl-2- | OLI0004 | 2- | 148 |
| | butenal | | methyltetrahydrofuran- | |
| | | | 3-one | |
| OLI0013 | trans-2-methyl-2- | OLI0008 | cyclopentanone | 165 |
| | butenal | | | |
| OLI0013 | trans-2-methyl-2- | OLI0011 | ethylvinylcarbinol | 128 |
| | butenal | | | |
| OLI0002 | 2-ethylpyrazine | OLI0001 | 2,4-lutidine | 118 |
| OLI0002 | 2-ethylpyrazine | OLI0003 | 2-methoxypyrazine | 121 |
| OLI0002 | 2-ethylpyrazine | OLI0004 | 2- | 134 |
| | | | methyltetrahydrofuran- | |
| | | | 3-one | |
| OLI0002 | 2-ethylpyrazine | OLI0011 | ethylvinylcarbinol | 122 |
| OLI0003 | 2- | OLI0004 | 2- | 134 |
| | methoxypyrazine | | methyltetrahydrofuran- | |
| | | | 3-one | |
| OLI0003 | 2- | OLI0011 | ethylvinylcarbinol | 146 |
| | methoxypyrazine | | | |
| OLI0015 | 2,3- | OLI0024 | gamma-heptalactone | 102 |
| | dimethylpyrazine | | | |
| OLI0011 | ethylvinylcarbinol | OLI0004 | 2- | 124 |
| | | | methyltetrahydrofuran- | |
| | | | 3-one | |
| OLI0096 | cis-3-hexenyl | OLI0017 | 2-furyl methyl ketone | 147 |
| | formate | | | |
| OLI0099 | isoamyl | OLI0017 | 2-furyl methyl ketone | 118 |
| | propionate | | | |
| OLI0097 | hexyl formate | OLI0017 | 2-furyl methyl ketone | 115 |
| OLI0027 | methyl levulinate | OLI0025 | methanethiol acetate | 160 |
| OLI0027 | methyl levulinate | OLI0024 | gamma-heptalactone | 158 |
| OLI0027 | methyl levulinate | OLI0022 | ethyl acetoacetate | 144 |
| OLI0027 | methyl levulinate | OLI0021 | ethyl 3- | 126 |
| | | | hydroxyhexanoate | |
| OLI0027 | methyl levulinate | OLI0018 | 2-pentanone | 125 |
| OLI0027 | methyl levulinate | OLI0014 | 2,3,5- | 107 |
| | | | trimethylpyrazine | |

### Example 4

### Identification of Strong Activator Combinations

Following the experimentals outlined in Example 1, a series of combinations (listed in Table 8) were tested for their ability to activate cpA neuronal activity in electrophysiological extracellular single-sensillum studies. These combinations were added to the test solution at a concentration of 1% component A and 1% component B. Each of the combinations in the table yielded activity values of between 60 and 100 spk/sec and hence are considered strong activators. Where the combination of two components or compounds produced activity which was greater than the activity of either compound alone, the combination was considered synergistic. In the Table, “Act” refers to activity and “Cmpd” refers to compound.

TABLE 8
Strong Activator Combinations

| | | | | Act |
|---|---|---|---|---|
| Cmpd | | Cmpd | | (spk/ |
| No. | Component A | No. | Component B | sec) |
| OLI0014 | 2,3,5-trimethylpyrazine | OLI0018 | 2-pentanone | 63 |
| OLI0014 | 2,3,5-trimethylpyrazine | OLI0024 | gamma-heptalactone | 71 |
| OLI0014 | 2,3,5-trimethylpyrazine | OLI0028 | phenylacetaldehyde | 67 |
| OLI0015 | 2,3-dimethylpyrazine | OLI0014 | 2,3,5-trimethylpyrazine | 92 |
| OLI0015 | 2,3-dimethylpyrazine | OLI0019 | allylbutyrate | 61 |
| OLI0015 | 2,3-dimethylpyrazine | OLI0021 | ethyl 3- | 65 |
| | | | hydroxyhexanoate | |
| OLI0015 | 2,3-dimethylpyrazine | OLI0028 | phenylacetaladehyde | 77 |
| OLI0016 | 2-acetyl-5-methylfuran | OLI0014 | 2,3,5-trimethylpyrazine | 78 |
| OLI0016 | 2-acetyl-5-methylfuran | OLI0021 | ethyl 3- | 60 |
| | | | hydroxyhexanoate | |
| OLI0016 | 2-acetyl-5-methylfuran | OLI0024 | gamma-heptalactone | 92 |
| OLI0016 | 2-acetyl-5-methylfuran | OLI0029 | phenylpropylaldehyde | 64 |
| OLI0006 | 5-methylfurfural | OLI0013 | trans-2-methyl-2- | 99 |
| | | | butenal | |
| OLI0017 | 2-furylmethylketone | OLI0014 | 2,3,5-trimethylpyrazine | 91 |
| OLI0017 | 2-furylmethylketone | OLI0015 | 2,3-dimethylpyrazine | 78 |
| OLI0017 | 2-furylmethylketone | OLI0016 | 2-acetyl-5-methylfuran | 60 |
| OLI0092 | methylamylketone | OLI0017 | 2-furylmethylketone | 75 |
| OLI0092 | methylamylketone | OLI0024 | gamma-heptalactone | 60 |
| OLI0020 | Cinnamylnitrile | OLI0014 | 2,3,5-trimethylpyrazine | 62 |
| OLI0020 | Cinnamylnitrile | OLI0015 | 2,3-dimethylpyrazine | 62 |
| OLI0020 | Cinnamylnitrile | OLI0024 | gamma-heptalactone | 77 |
| OLI0020 | Cinnamylnitrile | OLI0029 | phenylpropylaldehyde | 64 |
| OLI0021 | ethyl 3-hydroxyhexanoate | OLI0028 | phenylacetaldehyde | 62 |
| OLI0022 | ethylacetoacetate | OLI0014 | 2,3,5-trimethylpyrazine | 76 |
| OLI0022 | ethylacetoacetate | OLI0015 | 2,3-dimethylpyrazine | 67 |
| OLI0022 | ethylacetoacetate | OLI0016 | 2-acetyl-5-methylfuran | 65 |
| OLI0022 | ethylacetoacetate | OLI0018 | 2-pentanone | 62 |
| OLI0022 | ethylacetoacetate | OLI0020 | cinnamylnitrile | 63 |
| OLI0022 | Ethylacetoacetate | OLI0021 | ethyl 3- | 68 |
| | | | hydroxyhexanoate | |
| OLI0022 | Ethylacetoacetate | OLI0024 | gamma-heptalactone | 87 |
| OLI0022 | ethylacetoacetate | OLI0028 | phenylacetaldehyde | 60 |
| OLI0024 | gamma-heptalactone | OLI0018 | 2-pentanone | 70 |
| OLI0024 | gamma-heptalactone | OLI0019 | allylbutyrate | 73 |
| OLI0024 | gamma-heptalactone | OLI0021 | ethyl 3- | 75 |
| | | | hydroxyhexanoate | |
| OLI0024 | gamma-heptalactone | OLI0028 | phenylacetaldehyde | 69 |
| OLI0024 | gamma-heptalactone | OLI0029 | phenylpropylaldehyde | 64 |
| OLI0100 | methyl (E)-hex-3-enoate | OLI0014 | 2,3,5-trimethylpyrazine | 77 |
| OLI0100 | methyl (E)-hex-3-enoate | OLI0016 | 2-acetyl-5-methylfuran | 77 |
| OLI0100 | methyl (E)-hex-3-enoate | OLI0024 | gamma-heptalactone | 82 |
| OLI0098 | isoamyl formate | OLI0017 | 2-furyl methyl ketone | 83 |
| OLI0097 | hexyl formate | OLI0024 | gamma-heptalactone | 82 |
| OLI0097 | hexyl formate | OLI0014 | 2,3,5-trimethylpyrazine | 75 |
| OLI0096 | cis-3-hexenyl formate | OLI0024 | gamma-heptalactone | 72 |
| OLI0098 | isoamyl formate | OLI0014 | 2,3,5-trimethylpyrazine | 69 |
| OLI0099 | isoamyl propionate | OLI0014 | 2,3,5-trimethylpyrazine | 69 |
| OLI0098 | isoamyl formate | OLI0024 | gamma-heptalactone | 63 |
| OLI0098 | isoamyl formate | OLI0022 | ethyl acetoacetate | 63 |
| OLI0027 | methyl levulinate | OLI0015 | 2,3-dimethylpyrazine | 97 |
| OLI0027 | methyl levulinate | OLI0029 | phenyl propyl aldehyde | 96 |
| OLI0008 | Cyclopentanone | OLI0063 | propyl formate | 92 |
| OLI0027 | methyl levulinate | OLI0026 | methyl crotonate | 92 |
| OLI0091 | methyl heptanoate | OLI0025 | methanethiol acetate | 89 |
| OLI0018 | 2-pentanone | OLI0063 | propyl formate | 80 |
| OLI0027 | methyl levulinate | OLI0019 | allyl butyrate | 78 |
| OLI0027 | methyl levulinate | OLI0020 | cinnamyl nitrile | 70 |

### Example 5

### Identification of Synergistic Combinations

Following the experimentals outlined in Example 1, the combinations described in Table 9 were also used in electrophysiological extracellular single-sensillum studies. These combinations were added to the test solution at a concentration of 1% component A and 1% component B.

It was noted that the individual components yielded only moderate activity (moderate activator class, 40-60 spk/sec), mild activity (mild activator class, 20-40 spk/sec) or are only known to stimulate cpB and cpC neurons (beta activator class) when tested individually. Surprisingly, the components work synergistically to stimulate neuronal activity when combined as listed in Table 9, leading to activity values greater than 60 spk/sec.

Some combinations tested included the mild inhibitor methyl heptanoate or methylamylketone. Unexpectedly, compositions comprising methylamylketone and 2-furylmethylketone or gamma-heptalactone acted as strong activators of neuronal activity. Likewise, compositions comprising methyl heptanoate and methanethiol acetate also acted as strong activators of neuronal activity. In the Table, “Act” refers to activity, “Cmpd” refers to compound, “Comp” refers to component, “Mod” refers to moderate, “Inh” refers to inhibitor and “Actv” refers to activator.

TABLE 9
Synergistic Combinations Yielding Strong or Very Strong Activity

| | | | | | | Act |
|---|---|---|---|---|---|---|
| Cmpd | | Comp A | Cmpd | | Comp B | (spk/ |
| No. | Comp A | Class | No. | Comp B | Class | sec) |
| OLI0014 | 2,3,5- | Mod | OLI0018 | 2-pentanone | Mod | 63 |
| | trimethylpyrazine | Actv | | | Actv | |
| OLI0014 | 2,3,5- | Mod | OLI0020 | cinnamylnitrile | Mod | 62 |
| | trimethylpyrazine | Actv | | | Actv | |
| OLI0014 | 2,3,5- | Mod | OLI0024 | gamma-heptalactone | Mod | 71 |
| | trimethylpyrazine | Actv | | | Actv | |
| OLI0014 | 2,3,5- | Mod | OLI0100 | methyl (E)-hex-3- | Beta | 77 |
| | trimethylpyrazine | Actv | | enoate | Actv | |
| OLI0014 | 2,3,5- | Mod | OLI0028 | phenylacetaldehyde | Mod | 67 |
| | trimethylpyrazine | Actv | | | Actv | |
| OLI0015 | 2,3-dimethylpyrazine | Mod | OLI0014 | 2,3,5- | Mod | 92 |
| | | Actv | | trimethylpyrazine | Actv | |
| OLI0015 | 2,3-dimethylpyrazine | Mod | OLI0019 | allylbutyrate | Mod | 61 |
| | | Actv | | | Actv | |
| OLI0015 | 2,3-dimethylpyrazine | Mod | OLI0020 | cinnamylnitrile | Mod | 62 |
| | | Actv | | | Actv | |
| OLI0015 | 2,3-dimethylpyrazine | Mod | OLI0021 | ethyl 3- | Mod | 65 |
| | | Actv | | hydroxyhexanoate | Actv | |
| OLI0015 | 2,3-dimethylpyrazine | Mod | OLI0024 | gamma-heptalactone | Mod | 102 |
| | | Actv | | | Actv | |
| OLI0015 | 2,3-dimethylpyrazine | Mod | OLI0028 | phenylacetaladehyde | Mod | 77 |
| | | Actv | | | Actv | |
| OLI0017 | 2-furylmethylketone | Mod | OLI0014 | 2,3,5- | Mod | 91 |
| | | Actv | | trimethylpyrazine | Actv | |
| OLI0017 | 2-furylmethylketone | Mod | OLI0015 | 2,3-dimethylpyrazine | Mod | 78 |
| | | Actv | | | Actv | |
| OLI0017 | 2-furylmethylketone | Mod | OLI0016 | 2-acetyl-5- | Mod | 60 |
| | | Actv | | methylfuran | Actv | |
| OLI0017 | 2-furylmethylketone | Mod | OLI0020 | cinnamylnitrile | Mod | 115 |
| | | Actv | | | Actv | |
| OLI0017 | 2-furylmethylketone | Mod | OLI0022 | ethylacetoacetate | Mod | 112 |
| | | Actv | | | Actv | |
| OLI0017 | 2-furylmethylketone | Mod | OLI0092 | methylamylketone | Mild Inh | 75 |
| | | Actv | | | | |
| OLI0016 | 2-acetyl-5- | Mod | OLI0014 | 2,3,5- | Mod | 78 |
| | methylfuran | Actv | | trimethylpyrazine | Actv | |
| OLI0016 | 2-acetyl-5- | Mod | OLI0021 | ethyl 3- | Mod | 60 |
| | methylfuran | Actv | | hydroxyhexanoate | Actv | |
| OLI0016 | 2-acetyl-5- | Mod | OLI0024 | gamma-heptalactone | Mod | 92 |
| | methylfuran | Actv | | | Actv | |
| OLI0016 | 2-acetyl-5- | Mod | OLI0100 | methyl (E)-hex-3- | Beta | 77 |
| | methylfuran | Actv | | enoate | Actv | |
| OLI0016 | 2-acetyl-5- | Mod | OLI0029 | phenylpropylaldehyde | Mod | 64 |
| | methylfuran | Actv | | | Actv | |
| OLI0022 | ethylacetoacetate | Mod | OLI0014 | 2,3,5- | Mod | 76 |
| | | Actv | | trimethylpyrazine | Actv | |
| OLI0022 | ethylacetoacetate | Mod | OLI0015 | 2,3-dimethylpyrazine | Mod | 67 |
| | | Actv | | | Actv | |
| OLI0022 | ethylacetoacetate | Mod | OLI0016 | 2-acetyl-5- | Mod | 65 |
| | | Actv | | methylfuran | Actv | |
| OLI0022 | ethylacetoacetate | Mod | OLI0018 | 2-pentanone | Mod | 62 |
| | | Actv | | | Actv | |
| OLI0022 | ethylacetoacetate | Mod | OLI0020 | cinnamylnitrile | Mod | 63 |
| | | Actv | | | Actv | |
| OLI0022 | ethylacetoacetate | Mod | OLI0021 | ethyl 3- | Mod | 68 |
| | | Actv | | hydroxyhexanoate | Actv | |
| OLI0022 | ethylacetoacetate | Mod | OLI0024 | gamma-heptalactone | Mod | 87 |
| | | Actv | | | Actv | |
| OLI0022 | ethylacetoacetate | Mod | OLI0028 | phenylacetaldehyde | Mod | 60 |
| | | Actv | | | Actv | |
| OLI0024 | gamma-heptalactone | Mod | OLI0018 | 2-pentanone | Mod | 70 |
| | | Actv | | | Actv | |
| OLI0024 | gamma-heptalactone | Mod | OLI0019 | allylbutyrate | Mod | 73 |
| | | Actv | | | Actv | |
| OLI0024 | gamma-heptalactone | Mod | OLI0020 | cinnamylnitrile | Mod | 77 |
| | | Actv | | | Actv | |
| OLI0024 | gamma-heptalactone | Mod | OLI0021 | ethyl 3- | Mod | 75 |
| | | Actv | | hydroxyhexanoate | Actv | |
| OLI0024 | gamma-heptalactone | Mod | OLI0100 | methyl (E)-hex-3- | Beta | 82 |
| | | Actv | | enoate | Actv | |
| OLI0024 | gamma-heptalactone | Mod | OLI0092 | methylamylketone | Mild Inh | 60 |
| | | Actv | | | | |
| OLI0024 | gamma-heptalactone | Mod | OLI0029 | phenylpropylaldehyde | Mod | 64 |
| | | Actv | | | Actv | |
| OLI0024 | gamma-heptalactone | Mod | OLI0028 | phenylacetaldehyde | Mod | 69 |
| | | Actv | | | Actv | |
| OLI0029 | phenylpropylaldehyde | Mod | OLI0020 | cinnamylnitrile | Mod | 64 |
| | | Actv | | | Actv | |
| OLI0021 | ethyl 3- | Mod | OLI0028 | phenylacetaldehyde | Mod | 62 |
| | hydroxyhexanoate | Actv | | | Actv | |
| OLI0018 | 2-pentanone | Mod | OLI0063 | propyl formate | Mild | 80 |
| | | Actv | | | Actv | |
| OLI0091 | methyl heptanoate | Mild Inh | OLI0025 | methanethiol acetate | Mod | 89 |
| | | | | | Actv | |
| OLI0027 | methyl levulinate | Mod | OLI0020 | cinnamyl nitrile | Mod | 70 |
| | | Actv | | | Actv | |
| OLI0027 | methyl levulinate | Mod | OLI0029 | phenyl propyl | Mod | 96 |
| | | Actv | | aldehyde | Actv | |
| OLI0027 | methyl levulinate | Mod | OLI0015 | 2,3-dimethylpyrazine | Mod | 97 |
| | | Actv | | | Actv | |
| OLI0027 | methyl levulinate | Mod | OLI0026 | methyl crotonate | Mod | 92 |
| | | Actv | | | Actv | |
| OLI0027 | methyl levulinate | Mod | OLI0019 | allyl butyrate | Mod | 78 |
| | | Actv | | | Actv | |
| OLI0027 | methyl levulinate | Mod | OLI0014 | 2,3,5- | Mod | 107 |
| | | Actv | | trimethylpyrazine | Actv | |
| OLI0027 | methyl levulinate | Mod | OLI0022 | ethyl acetoacetate | Mod | 144 |
| | | Actv | | | Actv | |
| OLI0027 | methyl levulinate | Mod | OLI0025 | methanethiol acetate | Mod | 160 |
| | | Actv | | | Actv | |
| OLI0027 | methyl levulinate | Mod | OLI0021 | ethyl 3- | Mod | 126 |
| | | Actv | | hydroxyhexanoate | Actv | |
| OLI0027 | methyl levulinate | Mod | OLI0024 | gamma-heptalactone | Mod | 158 |
| | | Actv | | | Actv | |
| OLI0027 | methyl levulinate | Mod | OLI0018 | 2-pentanone | Mod | 125 |
| | | Actv | | | Actv | |

### Example 6

### Identification of Sensory Neuron Modulators-Inhibitors

Following the protocol of Example 1, compounds and combinations were tested for their ability to inhibit CO2-responsive neuronal activity. To analyze neuronal inhibition, activity levels recorded that fell below baseline activity levels were expressed as a percent reduction in activity over the baseline level.

When tested in the present assay, a number of compounds led to a reduction in cpA neuronal activity. Depending on the percent reduction in activity compared to baseline values, these compounds were classified as strong inhibitors (reducing activity >60%), moderate inhibitors (reducing activity by 40-60%) and mild inhibitors (reducing activity by 20-40%). A list of the single compounds tested and their inhibition level or class is given in Table 10.

TABLE 10
Inhibitor Compounds

| Compound | | |
|---|---|---|
| No. | Compound | Class |
| OLI0067 | 2,3-diethyl-5-methylpyrazine | Strong Inhibitor |
| OLI0068 | 2,3-diethylpyrazine | Strong Inhibitor |
| OLI0069 | 2-ethyl-3-methylpyrazine | Strong Inhibitor |
| OLI0070 | 2-methoxy-3-methylpyrazine | Strong Inhibitor |
| OLI0071 | 2-ethyl-3-methoxypyrazine | Moderate Inhibitor |
| OLI0072 | 2-methoxy-3(5or6)isopropylpyrazine | Moderate Inhibitor |
| OLI0073 | cis-3-hexenylacetate | Moderate Inhibitor |
| OLI0074 | furfurylpentanoate | Moderate Inhibitor |
| OLI0075 | octanone-3 | Moderate Inhibitor |
| OLI0076 | phenethylpropionate | Moderate Inhibitor |
| OLI0077 | trans-2-decenal | Moderate Inhibitor |
| OLI0078 | (Z)-hept-3-enylacetate | Mild Inhibitor |
| OLI0079 | 1-ethylhexyl tiglate | Mild Inhibitor |
| OLI0080 | 1-octanol | Mild Inhibitor |
| OLI0081 | 2,5-dimethyl-4-methoxy-3(2H) | Mild Inhibitor |
| | furanone | |
| OLI0082 | alpha,alpha-dimethyl phenethyl | Mild Inhibitor |
| | butyrate | |
| OLI0083 | cis-3-hexenyl butyrate | Mild Inhibitor |
| OLI0084 | cis-5-octen-1-ol | Mild Inhibitor |
| OLI0085 | ethyl nicotinate | Mild Inhibitor |
| OLI0086 | ethylheptanoate | Mild Inhibitor |
| OLI0087 | Eucalyptol | Mild Inhibitor |
| OLI0088 | furfurylpentenoate | Mild Inhibitor |
| OLI0089 | geranylacetone | Mild Inhibitor |
| OLI0090 | geranylbutyrate | Mild Inhibitor |
| OLI0091 | methyl heptanoate | Mild Inhibitor |
| OLI0092 | methylamylketone | Mild Inhibitor |
| OLI0093 | rosemary oil | Mild Inhibitor |
| OLI0094 | whiskey lactone | Mild Inhibitor |
| OLI0095 | veratraldehyde | Mild Inhibitor |

### Example 7

### Identification of Strong Inhibitor Combinations

Following the protocol of Example 1, combinations listed in Table 11 were tested for their ability to inhibit CO2-responsive neuronal activity. Combinations comprising either 2 or 3 components were tested for their ability to inhibit neuronal activity. The combinations listed in Table 11 are 2-component combinations that led to a >50% reduction in neuronal activity as compared to baseline activity. For the combinations of Table 11, the concentration of each component was 1%. In the Table, “Act” refers to activity, “Red” refers to reduction and “Cmpd” refers to compound.

TABLE 11
Two-Component Inhibitor Compositions

| | | | | Act |
|---|---|---|---|---|
| Cmpd | | Cmpd | | (% |
| No. | Component A | No. | Component B | Red) |
| OLI0102 | Eugenol | OLI0089 | geranylacetone | 64 |
| OLI0102 | Eugenol | OLI0078 | (Z)-hept-3-enylacetate | 79 |
| OLI0102 | Eugenol | OLI0080 | 1-octanol | 81 |
| OLI0102 | Eugenol | OLI0082 | alpha,alpha- | 73 |
| | | | dimethylphenethylbutyrate | |
| OLI0102 | Eugenol | OLI0083 | cis-3-hexenylbutyrate | 72 |
| OLI0102 | Eugenol | OLI0084 | cis-5-octen-1-ol | 77 |
| OLI0102 | Eugenol | OLI0074 | furfurylpentanoate | 72 |
| OLI0102 | Eugenol | OLI0095 | veratraldehyde | 68 |
| OLI0093 | rosemary oil | OLI0102 | eugenol | 74 |
| OLI0093 | rosemary oil | OLI0089 | geranylacetone | 61 |
| OLI0093 | rosemary oil | OLI0084 | cis-5-octen-1-ol | 64 |
| OLI0100 | methyl (E)-hex-3-enoate | OLI0071 | 2-ethyl-3-methoxypyrazine | 63 |
| OLI0076 | Phenethylpropionate | OLI0072 | 2-methoxy- | 56 |
| | | | 3(5or6)isopropylpyrazine | |
| OLI0076 | Phenethylpropionate | OLI0074 | furfurylpentanoate | 57 |
| OLI0076 | Phenethylpropionate | OLI0077 | trans-2-decenal | 58 |
| OLI0076 | Phenethylpropionate | OLI0071 | 2-ethyl-3-methoxypyrazine | 73 |
| OLI0071 | 2-ethyl-3-methoxypyrazine | OLI0072 | 2-methoxy- | 78 |
| | | | 3(5or6)isopropylpyrazine | |
| OLI0071 | 2-ethyl-3-methoxypyrazine | OLI0073 | cis-3-hexenylacetate | 73 |
| OLI0071 | 2-ethyl-3-methoxypyrazine | OLI0074 | furfurylpentanoate | 79 |
| OLI0071 | 2-ethyl-3-methoxypyrazine | OLI0075 | octanone-3 | 69 |
| OLI0071 | 2-ethyl-3-methoxypyrazine | OLI0077 | trans-2-decenal | 76 |
| OLI0068 | 2,3-diethylpyrazine | OLI0067 | 2,3-diethyl-5-methylpyrazine | 100 |
| OLI0068 | 2,3-diethylpyrazine | OLI0070 | 2-methoxy-3-methylpyrazine | 100 |
| OLI0068 | 2,3-diethylpyrazine | OLI0069 | 2-ethyl-3-methylpyrazine | 94 |
| OLI0015 | 2,3-dimethylpyrazine | OLI0100 | methyl (E)-hex-3-enoate | 87 |
| OLI0067 | 2,3-diethyl-5-methylpyrazine | OLI0070 | 2-methoxy-3-methylpyrazine | 100 |

The combinations listed in Table 12 comprise 3 components and lead to a >60% reduction in CO2-responsive neuronal activity. In the three-component combinations tested, each component was present in the test solution at a concentration of 0.6%. In the Table, “Act” refers to activity, “Red” refers to reduction, “Comp” refers to component and “Cmpd” refers to compound.

TABLE 12
Three-Inhibitor Combinations

| | | | | | | Act |
|---|---|---|---|---|---|---|
| | | | | | | (% |
| Cmpd | Comp A | Cmpd | Comp B | Cmpd | Comp C | Red) |
| OLI0078 | (Z)-hept-3-enyl | OLI0102 | eugenol | OLI0071 | 2-ethyl-3- | 96 |
| | acetate | | | | methoxypyrazine | |
| OLI0080 | 1-octanol | OLI0102 | eugenol | OLI0071 | 2-ethyl-3- | 100 |
| | | | | | methoxypyrazine | |
| OLI0068 | 2,3- | OLI0102 | eugenol | OLI0078 | (Z)-hept-3- | 97 |
| | diethylpyrazine | | | | enylacetate | |
| OLI0068 | 2,3- | OLI0102 | eugenol | OLI0080 | 1-octanol | 97 |
| | diethylpyrazine | | | | | |
| OLI0068 | 2,3- | OLI0071 | 2-ethyl-3- | OLI0072 | 2-methoxy- | 100 |
| | diethylpyrazine | | methoxypyrazine | | 3(5or6)isopropyl | |
| | | | | | pyrazine | |
| OLI0068 | 2,3- | OLI0071 | 2-ethyl-3- | OLI0074 | furfurylpentanoate | 100 |
| | diethylpyrazine | | methoxypyrazine | | | |
| OLI0072 | 2-methoxy- | OLI0071 | 2-ethyl-3- | OLI0078 | (Z)-hept-3- | 98 |
| | 3(5or6)isopropyl | | methoxypyrazine | | enylacetate | |
| | pyrazine | | | | | |
| OLI0072 | 2-methoxy- | OLI0071 | 2-ethyl-3- | OLI0080 | 1-octanol | 92 |
| | 3(5or6)isopropyl | | methoxypyrazine | | | |
| | pyrazine | | | | | |
| OLI0072 | 2-methoxy- | OLI0071 | 2-ethyl-3- | OLI0102 | eugenol | 98 |
| | 3(5or6)isopropyl | | methoxypyrazine | | | |
| | pyrazine | | | | | |
| OLI0074 | furfurylpentanoate | OLI0071 | 2-ethyl-3- | OLI0072 | 2-methoxy- | 93 |
| | | | methoxypyrazine | | 3(5or6)isopropyl | |
| | | | | | pyrazine | |
| OLI0074 | furfurylpentanoate | OLI0071 | 2-ethyl-3- | OLI0102 | eugenol | 98 |
| | | | methoxypyrazine | | | |
| OLI0100 | methyl (E)-hex-3- | OLI0068 | 2,3- | OLI0080 | 1-octanol | 97 |
| | enoate | | diethylpyrazine | | | |
| OLI0100 | methyl (E)-hex-3- | OLI0068 | 2,3- | OLI0071 | 2-ethyl-3- | 99 |
| | enoate | | diethylpyrazine | | methoxypyrazine | |
| OLI0100 | methyl (E)-hex-3- | OLI0068 | 2,3- | OLI0072 | 2-methoxy- | 99 |
| | enoate | | diethylpyrazine | | 3(5or6)isopropyl | |
| | | | | | pyrazine | |
| OLI0100 | methyl (E)-hex-3- | OLI0068 | 2,3- | OLI0102 | eugenol | 94 |
| | enoate | | diethylpyrazine | | | |
| OLI0100 | methyl (E)-hex-3- | OLI0068 | 2,3- | OLI0074 | furfurylpentanoate | 100 |
| | enoate | | diethylpyrazine | | | |
| OLI0100 | methyl (E)-hex-3- | OLI0068 | 2,3- | OLI0078 | (Z)-hept-3- | 96 |
| | enoate | | diethylpyrazine | | enylacetate | |

### Example 8

### Identification of Synergistic Inhibitor Combinations

Interestingly, some 2 and 3-component combinations yield >60% reduction in activity where the individual components yielded only moderate (40-60%) or mild (20-40%) inhibition or are known only to activate cpB and cpC neurons (beta activators). Unexpectedly, in one embodiment, a moderate activator, 2,3-dimethyl pyrazine, when combined with a beta activator, methyl (E)-hex-3-enoate, also led to a >60% reduction in activity.

The combinations listed in Table 13 have been shown, for the first time, to work synergistically when combined to inhibit neuronal activity in mosquitoes. In the study, two-component combinations comprised test solutions of 1% each of component A and component B while three-component combinations comprised test solutions of 0.6% of each of components A, B and C. An “x” in the Table indicates the component was not present. In the Table, “Act” refers to activity, “Cmpd” refers to compound, “Comp” refers to component, “Red” refers to reduced, “Mod” refers to moderate, “Inh” refers to inhibitor and “Actv” refers to activator.

TABLE 13
Inhibitor Compositions with Synergistic Effects

| | | | | | | | | | Act |
|---|---|---|---|---|---|---|---|---|---|
| Cmpd | | | Cmpd | | | Cmpd | | | (% |
| No. | Comp A | Class A | No. | Comp B | Class B | No. | Comp C | Class C | Red) |
| OLI0093 | rosemary | Mild | OLI0089 | geranyl | Mild | | x | x | 61 |
| | oil | Inh | | acetone | Inh | | | | |
| OLI0093 | rosemary | Mild | OLI0084 | cis-5-octen- | Mild | | x | x | 64 |
| | oil | Inh | | 1-ol | Inh | | | | |
| OLI0093 | rosemary | Mild | OLI0102 | eugenol | Mild | | x | x | 74 |
| | oil | Inh | | | Inh | | | | |
| OLI0102 | eugenol | Mild | OLI0089 | geranyl | Mild | | x | x | 64 |
| | | Inh | | acetone | Inh | | | | |
| OLI0102 | eugenol | Mild | OLI0078 | (Z)-hept-3- | Mild | | x | x | 79 |
| | | Inh | | enylacetate | Inh | | | | |
| OLI0102 | eugenol | Mild | OLI0082 | alpha,alpha- | Mild | | x | x | 73 |
| | | Inh | | dimethyl | Inh | | | | |
| | | | | phenethyl- | | | | | |
| | | | | butyrate | | | | | |
| OLI0102 | eugenol | Mild | OLI0083 | cis-3-hexenyl | Mild | | x | x | 72 |
| | | Inh | | butyrate | Inh | | | | |
| OLI0102 | eugenol | Mild | OLI0084 | cis-5-octen- | Mild | | x | x | 77 |
| | | Inh | | 1-ol | Inh | | | | |
| OLI0102 | eugenol | Mild | OLI0074 | furfuryl | Mod | | x | x | 72 |
| | | Inh | | pentanoate | Inh | | | | |
| OLI0102 | eugenol | Mild | OLI0095 | veratraldehyde | Mild | | x | x | 68 |
| | | Inh | | | Inh | | | | |
| OLI0102 | eugenol | Mild | OLI0078 | (Z)-hept-3- | Mild | OLI0071 | 2-ethyl-3- | Mod | 96 |
| | | Inh | | enylacetate | Inh | | methoxy- | Inh | |
| | | | | | | | pyrazine | | |
| OLI0102 | eugenol | Mild | OLI0080 | 1-octanol | Mild | | x | x | 81 |
| | | Inh | | | Inh | | | | |
| OLI0102 | eugenol | Mild | OLI0080 | 1-octanol | Mild | OLI0071 | 2-ethyl-3- | Mod | 100 |
| | | Inh | | | Inh | | methoxy- | Inh | |
| | | | | | | | pyrazine | | |
| OLI0076 | phenethyl- | Mod | OLI0071 | 2-ethyl-3- | Mod | | x | x | 73 |
| | propionate | Inh | | methoxy | Inh | | | | |
| | | | | pyrazine | | | | | |
| OLI0071 | 2-ethyl-3- | Mod | OLI0072 | 2-methoxy- | Mod | | x | x | 78 |
| | methoxy- | Inh | | 3(5or6)iso | Inh | | | | |
| | pyrazine | | | propyl | | | | | |
| | | | | pyrazine | | | | | |
| OLI0071 | 2-ethyl-3- | Mod | OLI0072 | 2-methoxy- | Mod | OLI0078 | (Z)-hept-3- | Mild | 98 |
| | methoxy- | Inh | | 3(5or6)iso | Inh | | enylacetate | Inh | |
| | pyrazine | | | propyl | | | | | |
| | | | | pyrazine | | | | | |
| OLI0071 | 2-ethyl-3- | Mod | OLI0072 | 2-methoxy- | Mod | OLI0080 | 1-octanol | Mild | 92 |
| | methoxy- | Inh | | 3(5or6)iso | Inh | | | Inh | |
| | pyrazine | | | propyl | | | | | |
| | | | | pyrazine | | | | | |
| OLI0071 | 2-ethyl-3- | Mod | OLI0072 | 2-methoxy- | Mod | OLI0102 | Eugenol | Mild | 98 |
| | methoxy- | Inh | | 3(5or6)iso | Inh | | | Inh | |
| | pyrazine | | | propyl | | | | | |
| | | | | pyrazine | | | | | |
| OLI0071 | 2-ethyl-3- | Mod | OLI0100 | methyl (E)- | Beta | | X | x | 63 |
| | methoxy- | Inh | | hex-3-enoate | Actv | | | | |
| | pyrazine | | | | | | | | |
| OLI0071 | 2-ethyl-3- | Mod | OLI0073 | cis-3-hexenyl | Mod | | X | x | 73 |
| | methoxy- | Inh | | acetate | Inh | | | | |
| | pyrazine | | | | | | | | |
| OLI0071 | 2-ethyl-3- | Mod | OLI0074 | furfuryl | Mod | | X | x | 79 |
| | methoxy- | Inh | | pentanoate | Inh | | | | |
| | pyrazine | | | | | | | | |
| OLI0071 | 2-ethyl-3- | Mod | OLI0075 | octanone-3 | Mod | | X | x | 69 |
| | methoxy- | Inh | | | Inh | | | | |
| | pyrazine | | | | | | | | |
| OLI0071 | 2-ethyl-3- | Mod | OLI0077 | trans-2- | Mod | | X | x | 76 |
| | methoxy | Inh | | decenal | Inh | | | | |
| | pyrazine | | | | | | | | |
| OLI0074 | furfuryl- | Mod | OLI0071 | 2-ethyl-3- | Mod | OLI0072 | 2- | Mod | 93 |
| | pentanoate | Inh | | methoxy | Inh | | methoxy- | Inh | |
| | | | | pyrazine | | | 3(5or6)iso- | | |
| | | | | | | | propyl- | | |
| | | | | | | | pyrazine | | |
| OLI0074 | furfuryl- | Mod | OLI0071 | 2-ethyl-3- | Mod | OLI0102 | Eugenol | Mild | 98 |
| | pentanoate | Inh | | methoxy | Inh | | | Inh | |
| | | | | pyrazine | | | | | |
| OLI0100 | methyl | Beta | OLI0015 | 2,3-dimethyl | Mod | | X | x | 87 |
| | (E)- | Actv | | pyrazine | Actv | | | | |
| | hex-3- | | | | | | | | |
| | enoate | | | | | | | | |

### Example 9

### Identification of Environmentally Safe Compounds

Harmful chemicals are often used to control pests and biting insects. With increasing public awareness of the dangers posed by some chemicals to public health and to the environment, natural compounds have been increasingly explored as alternatives to synthetic or hazardous chemicals. To this end, the Environmental Protection Agency has taken legislative action to categorize certain natural compounds as safe, protecting the use of these environmentally safe compounds from certain government regulations. The Federal Insecticide, Fungicide and Rodenticide Act (FIFRA) outlines the exemptions as well as compounds covered by the act. Among these compounds are eugenol (OLI0102), rosemary oil (OLI0093), peppermint oil (OLI0101) and phenethylpropionate (OLI0076.)

Eugenol, rosemary oil, peppermint oil and phenethylpropionate were tested in the present assay for their effect on neuronal activity. Rosemary oil and eugenol were found to be mild inhibitors, phenethylpropionate was found to be a moderate inhibitor and peppermint oil was found to be a beta activator.

Combinations containing environmentally safe compounds were tested for inhibitory activity in the compositions listed in Table 14 with either 2 or 3 components according to the method described in Example 1. Test solutions with two components were comprised of 1% of each component listed and test solutions with three components were comprised of 0.6% of each component listed. Component A in each combination is an environmentally safe compound. An “x” in the Table indicates that no component was present. In the Table, “Act” refers to activity, “Cmpd” refers to compound, “Comp” refers to component and “Red” refers to reduced.

TABLE 14
Inhibitory Combinations Containing at Least One Environmentally Safe
Compound

| | | | | | | Act |
|---|---|---|---|---|---|---|
| Cmpd | | Cmpd | | Cmpd | | (% |
| No. | Comp A | No. | Comp B | No. | Comp C | Red) |
| OLI0102 | eugenol | OLI0078 | (Z)-hept-3- | OLI0071 | 2-ethyl-3- | 96 |
| | | | enylacetate | | methoxy | |
| | | | | | pyrazine | |
| OLI0102 | eugenol | OLI0078 | (Z)-hept-3- | | X | 79 |
| | | | enylacetate | | | |
| OLI0102 | eugenol | OLI0080 | 1-octanol | OLI0071 | 2-ethyl-3- | 100 |
| | | | | | methoxy | |
| | | | | | pyrazine | |
| OLI0102 | eugenol | OLI0080 | 1-octanol | | X | 81 |
| OLI0102 | eugenol | OLI0068 | 2,3- | OLI0100 | methyl | 94 |
| | | | diethylpyrazine | | (E)-hex-3- | |
| | | | | | enoate | |
| OLI0102 | eugenol | OLI0068 | 2,3- | OLI0078 | (Z)-hept-3- | 97 |
| | | | diethylpyrazine | | enylacetate | |
| OLI0102 | eugenol | OLI0068 | 2,3- | OLI0080 | 1-octanol | 97 |
| | | | diethylpyrazine | | | |
| OLI0102 | eugenol | OLI0071 | 2-ethyl-3- | OLI0072 | 2- | 98 |
| | | | methoxy | | methoxy- | |
| | | | pyrazine | | 3(5or6)iso | |
| | | | | | propyl | |
| | | | | | pyrazine | |
| OLI0102 | eugenol | OLI0071 | 2-ethyl-3- | OLI0074 | Furfuryl | 98 |
| | | | methoxy | | pentanoate | |
| | | | pyrazine | | | |
| OLI0102 | eugenol | OLI0082 | alpha,alpha- | | X | 73 |
| | | | dimethyl | | | |
| | | | phenethyl | | | |
| | | | butyrate | | | |
| OLI0102 | eugenol | OLI0083 | cis-3-hexenyl | | X | 72 |
| | | | butyrate | | | |
| OLI0102 | eugenol | OLI0084 | cis-5-octen- | | X | 77 |
| | | | 1-ol | | | |
| OLI0102 | eugenol | OLI0074 | furfuryl | | X | 72 |
| | | | pentanoate | | | |
| OLI0102 | eugenol | OLI0089 | geranyl | | X | 64 |
| | | | acetone | | | |
| OLI0102 | eugenol | OLI0093 | rosemary oil | | X | 74 |
| OLI0102 | eugenol | OLI0095 | veratraldehyde | | X | 68 |
| OLI0076 | phenethyl | OLI0071 | 2-ethyl-3- | | X | 73 |
| | propionate | | methoxy | | | |
| | | | pyrazine | | | |
| OLI0076 | phenethyl | OLI0074 | furfuryl | | X | 57 |
| | propionate | | pentanoate | | | |
| OLI0076 | phenethyl | OLI0077 | trans-2- | | X | 58 |
| | propionate | | decenal | | | |
| OLI0076 | phenethyl | OLI0072 | 2-methoxy- | | X | 56 |
| | propionate | | 3(5or6)iso | | | |
| | | | propyl | | | |
| | | | pyrazine | | | |
| OLI0093 | rosemary | OLI0084 | cis-5-octen- | | X | 64 |
| | oil | | 1-ol | | | |
| OLI0093 | rosemary | OLI0089 | geranyl | | X | 61 |
| | oil | | acetone | | | |

### Example 10

### Identification of Activator Combinations Comprising Beta Activators

Carbon dioxide receptor neurons are housed within the basiconic sensilla of the mosquito maxillary palp. While activity from cpA neurons produces the largest amplitude spike, cpB and cpC neurons present in this region are also responsive to skin odors. Activity from these neurons can also be detected through the electrophysiological methods described in Example 1.

Although the activity from cpB and cpC neurons cannot easily be distinguished from one another, their collective activity can be distinguished from cpA neurons due to their production of spikes with much lower amplitude than those produced by cpA neurons.

In the present study, compounds identified as beta activators include methyl (E)-hex-3-enoate, furfurylpentanoate, cis-5-octen-1-ol, 1-ethylhexyltiglate, peppermint oil, isoamyl formate, cis-3-hexenyl formate, hexyl formate, methyl levulinate and isoamyl propionate.

Interestingly, furfurylpentanoate is also a moderate cpA inhibitor while cis-5-octen-1-ol and 1-ethylhexyltiglate are also mild cpA inhibitors. Methyl levulinate is also a moderate cpA activator.

Combinations containing beta activator components were tested using the assay previously described in Example 1 for their effect on cpA neuronal activity. It has been determined that different combinations are capable of either increased activity or reduced activity depending on the additional components included in the combination. Combinations containing at least one beta activator component resulted in increased cpA neuronal activity. The data are shown in Table 15. For each combination, the concentration of each of the two components was 1%. Surprisingly, when these components were combined with certain moderate activators, the resulting combinations acted as strong or very strong activators. In the Table, “Act” refers to activity, “Cmpd” refers to compound, “Comp” refers to component, “Mod” refers to moderate, and “Actv” refers to activator.

TABLE 15
Activator combinations comprising beta activators

| | | | | | | Act |
|---|---|---|---|---|---|---|
| Cmpd | | | Cmpd | | | (spk/ |
| No. | Comp A | Class A | No. | Comp B | Class B | sec) |
| OLI0100 | methyl (E)-hex-3- | Beta | OLI0014 | 2,3,5- | Mod | 77 |
| | enoate | Actv | | trimethylpyrazine | Actv | |
| OLI0100 | methyl (E)-hex-3- | Beta | OLI0016 | 2-acetyl-5- | Mod | 77 |
| | enoate | Actv | | methylfuran | Actv | |
| OLI0100 | methyl (E)-hex-3- | Beta | OLI0024 | gamma- | Mod | 82 |
| | enoate | Actv | | heptalactone | Actv | |
| OLI0098 | isoamyl formate | Beta | OLI0024 | gamma- | Mod | 63 |
| | | Actv | | heptalactone | Actv | |
| OLI0098 | isoamyl formate | Beta | OLI0022 | ethyl acetoacetate | Mod | 63 |
| | | Actv | | | Actv | |
| OLI0099 | isoamyl propionate | Beta | OLI0014 | 2,3,5- | Mod | 69 |
| | | Actv | | trimethylpyrazine | Actv | |
| OLI0098 | isoamyl formate | Beta | OLI0014 | 2,3,5- | Mod | 69 |
| | | Actv | | trimethylpyrazine | Actv | |
| OLI0096 | cis-3-hexenyl formate | Beta | OLI0024 | gamma- | Mod | 72 |
| | | Actv | | heptalactone | Actv | |
| OLI0097 | hexyl formate | Beta | OLI0014 | 2,3,5- | Mod | 75 |
| | | Actv | | trimethylpyrazine | Actv | |
| OLI0097 | hexyl formate | Beta | OLI0024 | gamma- | Mod | 82 |
| | | Actv | | heptalactone | Actv | |
| OLI0098 | isoamyl formate | Beta | OLI0017 | 2-furyl methyl | Mod | 83 |
| | | Actv | | ketone | Actv | |
| OLI0097 | hexyl formate | Beta | OLI0017 | 2-furyl methyl | Mod | 115 |
| | | Actv | | ketone | Actv | |
| OLI0099 | isoamyl propionate | Beta | OLI0017 | 2-furyl methyl | Mod | 118 |
| | | Actv | | ketone | Actv | |
| OLI0096 | cis-3-hexenyl formate | Beta | OLI0017 | 2-furyl methyl | Mod | 147 |
| | | Actv | | ketone | Actv | |
| OLI0027 | methyl levulinate | Beta | OLI0020 | cinnamyl nitrile | Mod | 70 |
| | | Actv | | | Actv | |
| OLI0027 | methyl levulinate | Beta | OLI0029 | phenyl propyl | Mod | 96 |
| | | Actv | | aldehyde | Actv | |
| OLI0027 | methyl levulinate | Beta | OLI0015 | 2,3- | Mod | 97 |
| | | Actv | | dimethylpyrazine | Actv | |
| OLI0027 | methyl levulinate | Beta | OLI0026 | methyl crotonate | Mod | 92 |
| | | Actv | | | Actv | |
| OLI0027 | methyl levulinate | Beta | OLI0019 | allyl butyrate | Mod | 78 |
| | | Actv | | | Actv | |
| OLI0027 | methyl levulinate | Beta | OLI0014 | 2,3,5- | Mod | 107 |
| | | Actv | | trimethylpyrazine | Actv | |
| OLI0027 | methyl levulinate | Beta | OLI0022 | ethyl acetoacetate | Mod | 144 |
| | | Actv | | | Actv | |
| OLI0027 | methyl levulinate | Beta | OLI0025 | methanethiol | Mod | 160 |
| | | Actv | | acetate | Actv | |
| OLI0027 | methyl levulinate | Beta | OLI0021 | ethyl 3- | Mod | 126 |
| | | Actv | | hydroxyhexanoate | Actv | |
| OLI0027 | methyl levulinate | Beta | OLI0024 | gamma- | Mod | 158 |
| | | Actv | | heptalactone | Actv | |
| OLI0027 | methyl levulinate | Beta | OLI0018 | 2-pentanone | Mod | 125 |
| | | Actv | | | Actv | |

### Example 11

### Identification of Inhibitor Combinations Comprising Beta Activators

Further investigation of beta activators revealed combinations containing at least one beta activator component that resulted in reduced cpA neuronal activity. These data are shown in Table 16. Where two components are in the combination, the concentration of each is 1%. Where three components were tested, the concentration of each was 0.6%.

In one test, the combination included the beta activator methyl (E)-hex-3-enoate with 2,3-dimethylpyrazine, a moderate activator. Unexpectedly, this composition acts as a strong inhibitor of neuronal activity.

Furfurylpentanoate is a common flavoring agent in food products. While furfurylpentanoate can act alone as a beta activator and as a moderate inhibitor of cpA neuronal activity, assays conducted with various combinations containing furfuryl pentanoate revealed a synergistic effects leading to strong inhibition of cpA neuronal activity.

In one example, a combination comprising furfurylpentanoate and eugenol, a mild inhibitor, yielded strong inhibition when tested.

In another example, a combination comprising furfurylpentanoate and 2-ethyl-3-methoxypyrazine (a moderate inhibitor) yielded strong inhibition when tested.

In another example, a combination comprising furfurylpentanoate, 2-ethyl-3-methoxypyrazine and 2-methoxy-3(5or6)isopropylpyrazine (a moderate inhibitor) yielded strong inhibition when tested.

In yet another example, a combination comprising furfurylpentanoate, 2-ethyl-3-methoxypyrazine and eugenol yielded strong inhibition when tested.

Another common flavoring agent, cis-5-octen-1-ol, is commonly used to impart a melon flavor in food items. This compound can act as both a beta activator as well as a mild inhibitor of cpA neuronal activity. Surprisingly, a combination including cis-5-octen-1-ol and eugenol yielded strong inhibition of cpA neuronal activity when tested. In the Table, “Act” refers to activity, “Cmpd” refers to compound, “Comp” refers to component, “Red” refers to reduction, “Mod” refers to moderate, “Strng” refers to strong, “Inh” refers to inhibitor and “Actv” refers to activator.

TABLE 16
Inhibitor combinations containing beta activators

| | | | | | | | | | Act |
|---|---|---|---|---|---|---|---|---|---|
| Cmpd | | | Cmpd | | | Cmpd | | | (% |
| No. | Comp A | Class A | No. | Comp B | Class B | No. | Comp C | Class C | Red) |
| OLI0100 | methyl (E)- | Beta | OLI0015 | 2,3- | Mod | | X | | 87 |
| | hex-3- | Actv | | dimethyl- | Actv | | | | |
| | enoate | | | pyrazine | | | | | |
| OLI0100 | methyl (E)- | Beta | OLI0068 | 2,3-diethyl- | Strng | OLI0080 | 1-octanol | Mild | 97 |
| | hex-3- | Actv | | pyrazine | Inh | | | Inh | |
| | enoate | | | | | | | | |
| OLI0100 | methyl (E)- | Beta | OLI0068 | 2,3-diethyl- | Strng | OLI0071 | 2-ethyl-3- | Mod | 99 |
| | hex-3- | Actv | | pyrazine | Inh | | methoxy | Inh | |
| | enoate | | | | | | pyrazine | | |
| OLI0100 | methyl (E)- | Beta | OLI0068 | 2,3-diethyl- | Strng | OLI0072 | 2-methoxy- | Mod | 99 |
| | hex-3- | Actv | | pyrazine | Inh | | 3(5or6)iso | Inh | |
| | enoate | | | | | | propyl | | |
| | | | | | | | pyrazine | | |
| OLI0100 | methyl (E)- | Beta | OLI0068 | 2,3-diethyl- | Strng | OLI0102 | Eugenol | Mild | 94 |
| | hex-3- | Actv | | pyrazine | Inh | | | Inh | |
| | enoate | | | | | | | | |
| OLI0100 | methyl (E)- | Beta | OLI0068 | 2,3-diethyl- | Strng | OLI0088 | furfuryl- | Beta | 100 |
| | hex-3- | Actv | | pyrazine | Inh | | pentanoate | Actv | |
| | enoate | | | | | | | and | |
| | | | | | | | | Mod | |
| | | | | | | | | Inh | |
| OLI0100 | methyl (E)- | Beta | OLI0068 | 2,3-diethy- | Strng | OLI0078 | (Z)-hept-3- | Mild | 96 |
| | hex-3- | Actv | | pyrazine | Inh | | enylacetate | Inh | |
| | enoate | | | | | | | | |
| OLI0074 | furfuryl- | Beta | OLI0102 | eugenol | Mild | | X | | 72 |
| | pentanoate | Actv | | | Inh | | | | |
| | | and | | | | | | | |
| | | Mod | | | | | | | |
| | | Inh | | | | | | | |
| OLI0074 | furfuryl- | Beta | OLI0076 | phenethyl- | Mod | | X | | 57 |
| | pentanoate | Actv | | propionate | Inh | | | | |
| | | and | | | | | | | |
| | | Mod | | | | | | | |
| | | Inh | | | | | | | |
| OLI0074 | furfuryl | Beta | OLI0071 | 2-ethyl-3- | Mod | | X | | 79 |
| | pentanoate | Actv | | methoxy- | Inh | | | | |
| | | and | | pyrazine | | | | | |
| | | Mod | | | | | | | |
| | | Inh | | | | | | | |
| OLI0074 | furfuryl- | Beta | OLI0071 | 2-ethyl-3- | Mod | OLI0068 | 2,3-diethyl- | Strng | 100 |
| | pentanoate | Actv | | methoxy- | Inh | | pyrazine | Inh | |
| | | and | | pyrazine | | | | | |
| | | Mod | | | | | | | |
| | | Inh | | | | | | | |
| OLI0074 | furfuryl- | Beta | OLI0071 | 2-ethyl-3- | Mod | OLI0072 | 2-methoxy- | Mod | 93 |
| | pentanoate | Actv | | methoxy- | Inh | | 3(5or6)iso | Inh | |
| | | and | | pyrazine | | | propyl | | |
| | | Mod | | | | | pyrazine | | |
| | | Inh | | | | | | | |
| OLI0074 | furfuryl- | Beta | OLI0071 | 2-ethyl-3- | Mod | OLI0102 | Eugenol | Mild | 98 |
| | pentanoate | Actv | | methoxy- | Inh | | | Inh | |
| | | and | | pyrazine | | | | | |
| | | Mod | | | | | | | |
| | | Inh | | | | | | | |
| OLI0084 | cis-5- | Beta | OLI0102 | eugenol | Mild | | X | | 77 |
| | octen-1-ol | Actv | | | Inh | | | | |
| | | and | | | | | | | |
| | | Mild | | | | | | | |
| | | Inh | | | | | | | |

### Example 12

### Area Behavior Assays

Behavior assays were developed to aid in the evaluation of compounds and compositions of the present invention. These assays include the landing assay and the netsphere assay. These assays were utilized to determine the effectiveness of said compounds and compositions with regard to attracting or repelling mosquitoes of the species Aedes aegypti. Due to the highly conserved nature of the carbon dioxide receptor across the order Diptera, the results obtained for Aedes aegypti are likely to be intuitive with regard to other members of the mosquito family Culicidae as well as with regard to other dipteran family members.

### Landing Assay

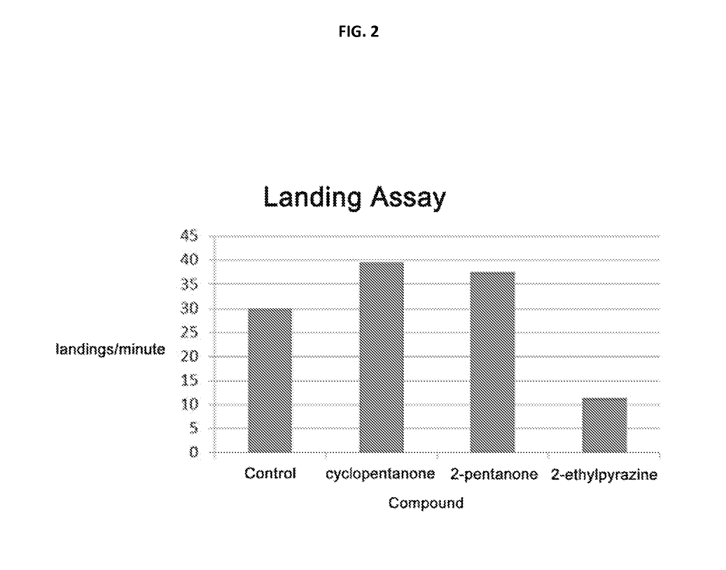

The landing assay is an assay used to test for attraction toward human skin. A human gloved hand with an opening cutout protected by 2 layers of mesh was inserted into a 12×12×12 inch cage of female mosquitoes. The first layer of mesh was used to protect the human from chemical contact as well as mosquito contact. A second layer of mesh was treated with a chemical compound or composition that had been dissolved at a concentration of 1% in acetone and allowed to dry on said mesh for three minutes. This second layer of mesh was placed on top of the first mesh layer. The two mesh layers were separated by outer magnetic strips to hold the layers in place on the glove. This experimental design allows the test subjects, starved female mosquitoes, to be exposed to human skin odors as well as the compound or composition concurrently. The cage contained 30 female and 3 male mosquitoes. The landing of mosquitoes on the treated surface was videotaped over a 5 minute time course and the number of landings during that time period was recorded. Mesh treated with acetone alone was used as a negative control. This experiment was done in triplicate for each compound or composition tested. The results from one such experiment are pictured in FIG. 2.

The data reveal that compounds cyclopentanone and 2-pentanone produced more landings, 39 and 37, respectively than the blank control, 30 landings. Furthermore, compound 2-ethylpyrazine resulted in 12 landings in the same timeframe, making it a repellent. Interestingly, this compound has been shown to be an activator of CO2-responsive neurons. In this example, this compound acts as a masking agent, interfering with the host-seeking response of the mosquitoes, presumably by overwhelming their CO2 receptors.

### Example 13

### Netsphere Assay

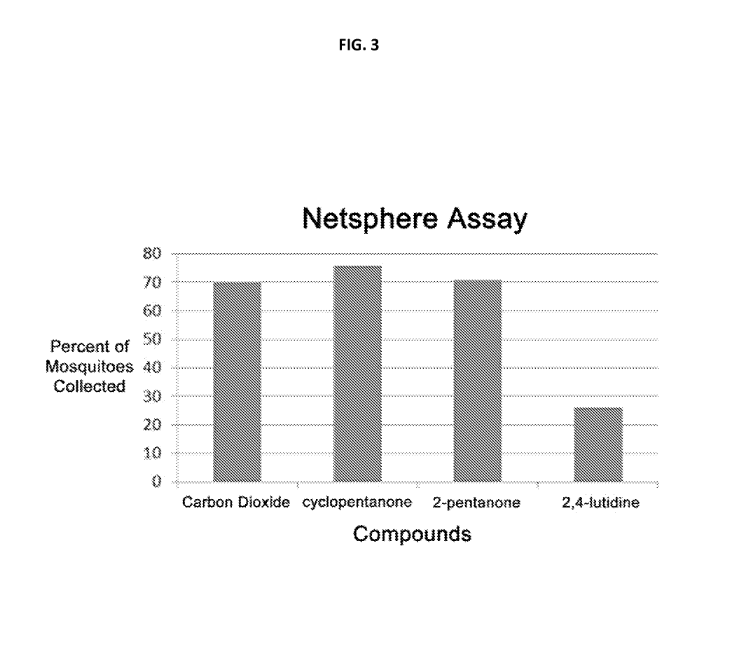

The netsphere assay was conducted in a semi-field containment area. The containment area was 1,000 square feet in size and environmental cues such as temperature, humidity, lighting and airflow were controlled to replicate conditions that Aedes aegypti mosquitoes would encounter in the wild. The containment area was conditioned for 2 hours prior to experimentation to allow for equalization of environmental conditions. Fifty female and five male mosquitoes were then released into the chamber and given one hour to acclimate to the environment. Following this, a BG-Sentinel trap (Biogents AG, Regensburg, Germany) was baited with either cyclopentanone, 2-pentanone or 2,4-lutidine and placed in the chamber in the presence of a non-baited BG-Sentinel (as a negative control for trap attraction). The collection was allowed to proceed overnight during which lighting conditions in the chamber were set to mimic those of starlight. The following day, mosquitoes caught in the trap were frozen at −20° C. and counted. These counts were compared to control experiments where CO2 from a tank, at a flow rate of 250 ml/min, was used as bait. The results of one such experiment are shown in FIG. 3.

The data reveal that compounds cyclopentanone and 2-pentanone act as attractants, similar to CO2 alone. Furthermore, compound 2,4-lutidine acted as a repellent. Interestingly, this compound has been shown to be a strong activator of CO2-responsive neurons suggesting that at the concentration used, the activation of these neurons by this compound leads to avoidance of the compound by the mosquitoes.

### Example 14

### Larvicidal Activity Assay

A 6-well plate (Corning Life Sciences, Tewksbury, Mass.) is used to test a compound's larvicidal activity. Approximately 20 larvae are added to each well under the following conditions: negative control (larvae are combined with 5 mL of distilled water); positive control (larvae are combined with 4.5 mL of distilled water with 0.5 mL of ethanol); treatment 1 [larvae are combined with 5 mL of a solution comprising 100 parts per million (ppm) of compound A]; treatment 2 (larvae are combined with 5 mL of a solution comprising 0.25% compound A); treatment 3 (larvae are combined with 5 mL of a solution comprising 100 ppm of compound B); treatment 4 (larvae are combined with 5 mL of a solution comprising 0.25% compound B). After a 24 hour exposure, the number of dead larvae are counted and recorded.

### Example 15

### Biocidal Activity Assay

The room is conditioned to 26° C. and 60-70% relative humidity. Bottles, lids and mesh coverings to be used are washed with plain dish soap. Bottles and lids are allowed to dry completely. A piece of number 1 Whattman filter paper is added to the bottom of each bottle. Forceps are used to properly position the filter paper against the bottom of the bottle. Each bottle is labeled with the dilution concentration to be applied to the filter paper. Serial dilutions are prepared in test tubes, starting with a dilution of 20 mg/mL. Tubes are labeled with the appropriate dilution concentrations.

Test compounds are subjected to serial dilution in eppendorf tubes, starting with a dilution of 20 mg/ml in 1000 μl of acetone and generating 10-fold dilutions in each successive tube. 500 μl of each solution (including an acetone-only control) is applied to the filter paper in corresponding bottles and allowed to dry. Twenty unstarved female mosquitoes are transferred into each bottle and the tops are sealed with mesh. Bottles are then placed into the conditioned experiment room for two hours. Mosquitoes are then observed and the number of catatonic mosquitoes in each bottle is recorded.

### Example 16

### Larvicidal and Biocidal Effect of Compounds of the Invention

Compounds of the present invention were analyzed according to the methods described in Examples 14 and 15. Larvicidal activity was assessed according to example 14 for compounds of the present invention at doses of 100 parts per million (ppm) and 0.25%. The results are presented in Table 17 as % lethality (the number of dead larvae divided by the total number of larvae).

TABLE 17
Larvicidal activity

| | | | % Lethality |
|---|---|---|---|
| | | % | with 0.25% |
| Compound | | Lethality at | compound |
| No. | Compound | 100 ppm | conc. |
| OLI0116 | Salicylaldehyde | 100% lethal | 100% lethal |
| OLI0005 | 4-ethylphenol | 100% lethal | 100% lethal |
| OLI0020 | cinnamyl nitrile | 100% lethal | 100% lethal |
| OLI0052 | Indole | 100% lethal | 100% lethal |
| OLI0101 | peppermint oil | 88% lethal | 100% lethal |
| OLI0059 | methyl heptadienone | 58% lethal | 100% lethal |
| OLI0075 | octanone-3 | 50% lethal | 100% lethal |
| OLI0017 | 2-furyl methyl ketone | 50% lethal | 100% lethal |
| OLI0111 | Menthalactone | 33% lethal | 100% lethal |
| OLI0102 | Eugenol | 25% lethal | 100% lethal |
| OLI0028 | phenylacetaldehyde | 25% lethal | 100% lethal |
| OLI0104 | allyl cinnamate | 15% lethal | 100% lethal |
| OLI0077 | trans-2-decenal | 10% lethal | 100% lethal |
| OLI0106 | cinnamic aldehyde | 10% lethal | 100% lethal |
| | dimethyl acetal | | |
| OLI0001 | 2,4-lutidine | 0% lethal | 100% lethal |
| OLI0003 | 2-methoxypyrazine | 0% lethal | 100% lethal |
| OLI0006 | 5-methyl furfural | 0% lethal | 100% lethal |
| OLI0009 | ethyl 2-furoate | 0% lethal | 100% lethal |
| OLI0012 | Guaiacol | 0% lethal | 100% lethal |
| OLI0016 | 2-acetyl-5-methyl furan | 0% lethal | 100% lethal |
| OLI0019 | allyl butyrate | 0% lethal | 100% lethal |
| OLI0024 | gamma-heptalactone | 0% lethal | 100% lethal |
| OLI0025 | methanethiol acetate | 0% lethal | 100% lethal |
| OLI0029 | phenyl propyl aldehyde | 0% lethal | 100% lethal |
| OLI0065 | trans-cinnamaldehyde | 0% lethal | 100% lethal |
| OLI0067 | 2,3-diethyl-5- | 0% lethal | 100% lethal |
| | methylpyrazine | | |
| OLI0068 | 2,3-diethylpyrazine | 0% lethal | 100% lethal |
| OLI0069 | 2-ethyl-3- | 0% lethal | 100% lethal |
| | methylpyrazine | | |
| OLI0070 | 2-methoxy-3- | 0% lethal | 100% lethal |
| | methylpyrazine | | |
| OLI0071 | 2-ethyl-3-methoxypyrazine | 0% lethal | 100% lethal |
| OLI0072 | 2-methoxy-3(5or6) | 0% lethal | 100% lethal |
| | isopropylpyrazine | | |
| OLI0074 | furfuryl pentanoate | 0% lethal | 100% lethal |
| OLI0076 | phenethyl propionate | 0% lethal | 100% lethal |
| OLI0079 | 1-ethylhexyl tiglate | 0% lethal | 100% lethal |
| OLI0084 | cis-5-octen-1-ol | 0% lethal | 100% lethal |
| OLI0100 | methyl (E)-hex-3-enoate | 0% lethal | 100% lethal |
| OLI0105 | trans-cinnamyl propionate | 0% lethal | 100% lethal |
| OLI0107 | cinnamyl formate | 0% lethal | 100% lethal |
| OLI0109 | cinnamyl propionate | 0% lethal | 100% lethal |
| OLI0110 | ethyl cinnamate | 0% lethal | 100% lethal |
| OLI0112 | methoxy cinnamic aldehyde | 0% lethal | 100% lethal |
| OLI0113 | methyl cinnamate | 0% lethal | 100% lethal |
| OLI0114 | methyl trans-cinnamate | 0% lethal | 100% lethal |
| OLI0115 | Menthol | 0% lethal | 100% lethal |
| OLI0117 | cinnamyl isobutyrate | 0% lethal | 100% lethal |
| OLI0118 | Ultrazur | 0% lethal | 100% lethal |
| OLI0073 | cis-3-hexenyl acetate | 0% lethal | 95% lethal |
| OLI0026 | methyl crotonate | 0% lethal | 87.5% lethal |
| OLI0008 | Cyclopentanone | 0% lethal | 85% lethal |
| OLI0092 | methyl amy ketone | 32% lethal | 73% lethal |
| OLI0013 | trans-2-methyl-2-butenal | 0% lethal | 72% lethal |
| OLI0091 | methyl heptanoate | 0% lethal | 72% lethal |
| OLI0002 | 2-ethylpyrazine | 0% lethal | 50% lethal |
| OLI0027 | methyl levulinate | 0% lethal | 50% lethal |
| OLI0066 | Valeraldehyde | 0% lethal | 35% lethal |
| OLI0096 | cis 3-hexenyl formate | 0% lethal | 30% lethal |
| OLI0011 | ethyl vinyl carbinol | 5% lethal | 27% lethal |
| OLI0014 | 2,3,5-trimethylpyrazine | 0% lethal | 21% lethal |
| OLI0119 | hexyl butyrate | 0% lethal | 15% lethal |
| OLI0097 | hexyl formate | 0% lethal | 5% lethal |
| OLI0018 | 2-pentanone | 0% lethal | 0% lethal |
| OLI0063 | propyl formate | 0% lethal | 0% lethal |
| OLI0015 | 2,3-dimethylpyrazine | 0% lethal | 0% lethal |
| OLI0004 | 2-methyltetrahydrofuran- | 0% lethal | 0% lethal |
| | 3-one | | |
| OLI0010 | ethyl lactate | 0% lethal | 0% lethal |
| OLI0021 | ethyl 3-hydroxyhexanoate | 0% lethal | 0% lethal |
| OLI0103 | phenethyl cinnamate | 0% lethal | 0% lethal |
| OLI0120 | benzyl cinnamate | 0% lethal | 0% lethal |
| OLI0007 | butyl formate | 0% lethal | 0% lethal |
| OLI0042 | ethyl 3-hydroxybutyrate | 0% lethal | 0% lethal |
| OLI0022 | ethyl acetoacetate | 0% lethal | 0% lethal |
| OLI0099 | isoamyl propionate | 0% lethal | 0% lethal |

Biocidal activity of compounds of the present invention was assessed according to the methods of Example 15. Compounds were tested at 0.2 mg/ml and 2 mg/ml. The results are presented in Table 18 as % mortality (the number of dead mosquitoes divided by the total number of mosquitoes).

TABLE 18
Biocidal activity

| | | % | |
|---|---|---|---|
| | | mortality | % mortality |
| Compound | | with | with |
| No. | Compound | 0.2 mg/ml | 2 mg/ml |
| OLI0108 | cinnamyl isobutyrate | 10 | 100 |
| OLI0005 | 4-ethylphenol | 0 | 100 |
| OLI0020 | cinnamyl nitrile | 0 | 100 |
| OLI0052 | Indole | 0 | 100 |
| OLI0076 | phenethylpropionate | 0 | 100 |
| OLI0077 | trans-2-decenal | 0 | 100 |
| OLI0102 | Eugenol | 0 | 100 |
| OLI0106 | cinnamic aldehyde | 0 | 100 |
| | dimethyl acetal | | |
| OLI0107 | cinnamyl formate | 0 | 100 |
| OLI0109 | cinnamyl propionate | 0 | 100 |
| OLI0110 | ethyl cinnamate | 0 | 100 |
| OLI0111 | menthalactone | 0 | 100 |
| OLI0112 | methoxy cinnamic aldehyde | 0 | 100 |
| OLI0113 | methyl cinnamate | 0 | 100 |
| OLI0114 | methyl trans-cinnamate | 0 | 100 |
| OLI0084 | cis-5-octen-1-ol | 0 | 95 |
| OLI0105 | trans-cinnamyl propionate | 0 | 85 |
| OLI0021 | ethyl 3-hydroxyhexanoate | 0 | 75 |
| OLI0104 | allyl cinnamate | 0 | 45 |
| OLI0103 | phenethyl cinnamate | 5 | 25 |
| OLI0029 | phenylpropylaldehyde | 0 | 15 |
| OLI0079 | 1-ethylhexyl tiglate | 0 | 15 |
| OLI0014 | 2,3,5-trimethylpyrazine | 0 | 0 |
| OLI0067 | 2,3-diethyl-5-methylpyrazine | 0 | 0 |
| OLI0068 | 2,3-diethylpyrazine | 0 | 0 |
| OLI0015 | 2,3-dimethylpyrazine | 0 | 0 |
| OLI0001 | 2,4-lutidine | 0 | 0 |
| OLI0016 | 2-acetyl-5-methyl furan | 0 | 0 |
| OLI0071 | 2-ethyl-3-methoxypyrazine | 0 | 0 |
| OLI0002 | 2-ethylpyrazine | 0 | 0 |
| OLI0017 | 2-furyl methyl ketone | 0 | 0 |
| OLI0032 | 2-methoxy-3(5or6) | 0 | 0 |
| | isopropylpyrazine | | |
| OLI0070 | 2-methoxy-3-methylpyrazine | 0 | 0 |
| OLI0003 | 2-methoxypyrazine | 0 | 0 |
| OLI0004 | 2-methyltetrahydrofuran-3-one | 0 | 0 |
| OLI0018 | 2-pentanone | 0 | 0 |
| OLI0069 | 2-ethyl-3-methylpyrazine | 0 | 0 |
| OLI0006 | 5-methyl furfural | 0 | 0 |
| OLI0019 | allyl butyrate | 0 | 0 |
| OLI0120 | benzyl cinnamate | 0 | 0 |
| OLI0007 | butyl formate | 0 | 0 |
| OLI0096 | cis 3-hexenyl formate | 0 | 0 |
| OLI0073 | cis-3-hexenyl acetate | 0 | 0 |
| OLI0008 | cyclopentanone | 0 | 0 |
| OLI0009 | ethyl 2-furoate | 0 | 0 |
| OLI0042 | ethyl 3-hydroxybutyrate | 0 | 0 |
| OLI0022 | ethyl acetoacetate | 0 | 0 |
| OLI0010 | ethyl lactate | 0 | 0 |
| OLI0011 | ethyl vinyl carbinol | 0 | 0 |
| OLI0074 | furfuryl pentanoate | 0 | 0 |
| OLI0024 | gamma-heptalactone | 0 | 0 |
| OLI0012 | Guaiacol | 0 | 0 |
| OLI0119 | hexyl butyrate | 0 | 0 |
| OLI0097 | hexyl formate | 0 | 0 |
| OLI0100 | methyl (E)-hex-3-enoate | 0 | 0 |
| OLI0099 | isoamyl propionate | 0 | 0 |
| OLI0115 | Menthol | 0 | 0 |
| OLI0025 | methanethiol acetate | 0 | 0 |
| OLI0092 | methylamylketone | 0 | 0 |
| OLI0026 | methyl crotonate | 0 | 0 |
| OLI0059 | methyl heptadienone | 0 | 0 |
| OLI0091 | methyl heptanoate | 0 | 0 |
| OLI0027 | methyl levulinate | 0 | 0 |
| OLI0075 | octanone-3 | 0 | 0 |
| OLI0101 | Peppermint oil | 0 | 0 |
| OLI0028 | phenylacetaldehyde | 0 | 0 |
| OLI0063 | propyl formate | 0 | 0 |
| OLI0116 | salicylaldehyde | 0 | 0 |
| OLI0013 | trans-2-methyl-2-butenal | 0 | 0 |
| OLI0065 | trans-cinnamaldehyde | 0 | 0 |
| OLI0118 | Ultrazur | 0 | 0 |
| OLI0066 | Valeraldehyde | 0 | 0 |

Biocidal activity of combinations comprising compounds of the present invention was assessed according to the methods of Example 15. Combinations were tested at 0.2 mg/ml and 2 mg/ml (total concentration of combined compounds). The results are presented in Table 19 as % mortality (the number of dead mosquitoes divided by the total number of mosquitoes). In the Table, “Mort” refers to mortality, “Cmpd” refers to compound and “Comp” refers to component.

TABLE 19
Combination biocidal activity

| Cmpd | | Cmpd | | Cmpd | | % Mort | % Mort |
|---|---|---|---|---|---|---|---|
| No. | Comp A | No. | Comp B | No. | Comp C | with 0.2 mg/ml | with 2.0 mg/ml |
| OLI0092 | methyl amyl | OLI0024 | gamma- | | x | 0 | 5 |
| | ketone | | heptalactone | | | | |
| OLI0076 | phenethyl | OLI0088 | furfuryl | | x | 0 | 100 |
| | propionate | | pentanoate | | | | |
| OLI0076 | phenethyl | OLI0071 | 2-ethyl-3- | | x | 0 | 100 |
| | propionate | | methoxy | | | | |
| | | | pyrazine | | | | |
| OLI0076 | phenethyl | OLI0072 | 2-methoxy- | | x | 0 | 100 |
| | propionate | | 3(5or6) | | | | |
| | | | isopropyl | | | | |
| | | | pyrazine | | | | |
| OLI0076 | phenethyl | OLI0077 | trans-2- | | x | 0 | 100 |
| | propionate | | decenal | | | | |
| OLI0071 | 2-ethyl-3- | OLI0088 | furfuryl | | x | 0 | 100 |
| | methoxy | | pentanoate | | | | |
| | pyrazine | | | | | | |
| OLI0071 | 2-ethyl-3- | OLI0077 | trans-2- | | x | 65 | 100 |
| | methoxy | | decenal | | | | |
| | pyrazine | | | | | | |
| OLI0071 | 2-ethyl-3- | OLI0072 | 2-methoxy- | | x | 0 | 45 |
| | methoxy | | 3(5or6) | | | | |
| | pyrazine | | isopropyl | | | | |
| | | | pyrazine | | | | |
| OLI0020 | cinnamyl | OLI0017 | 2-furyl methyl | | x | 0 | 95 |
| | nitrile | | ketone | | | | |
| OLI0020 | cinnamyl | OLI0029 | phenyl propyl | | x | 0 | 100 |
| | nitrile | | aldehyde | | | | |
| OLI0020 | cinnamyl | OLI0015 | 2,3-dimethyl | | x | 0 | 100 |
| | nitrile | | pyrazine | | | | |
| OLI0020 | cinnamyl | OLI0014 | 2,3,5-trimethyl | | x | 0 | 100 |
| | nitrile | | pyrazine | | | | |
| OLI0020 | cinnamyl | OLI0024 | gamma- | | x | 0 | 100 |
| | nitrile | | heptalactone | | | | |
| OLI0016 | 2-acetyl-5- | OLI0029 | phenyl propyl | | x | 0 | 70 |
| | methyl | | aldehyde | | | | |
| | furan | | | | | | |
| OLI0016 | 2-acetyl-5- | OLI0021 | ethyl 3- | | x | 10 | 100 |
| | methyl | | hydroxy | | | | |
| | furan | | hexanoate | | | | |
| OLI0089 | geranyl | OLI0102 | eugenol | | x | 0 | 100 |
| | acetone | | | | | | |
| OLI0089 | geranyl | OLI0093 | rosemary oil | | x | 0 | 100 |
| | acetone | | | | | | |
| OLI0093 | rosemary | OLI0102 | eugenol | | x | 0 | 100 |
| | oil | | | | | | |
| OLI0093 | rosemary | OLI0084 | cis-5- | | x | 0 | 100 |
| | oil | | octen-1-ol | | | | |
| OLI0102 | eugenol | OLI0095 | veratraldehyde | | x | 5 | 100 |
| OLI0102 | eugenol | OLI0080 | 1-octanol | | x | 0 | 100 |
| OLI0102 | eugenol | OLI0083 | cis-3-hexenyl | | x | 0 | 100 |
| | | | butyrate | | | | |
| OLI0102 | eugenol | OLI0082 | alpha,alpha- | | x | 0 | 100 |
| | | | dimethyl | | | | |
| | | | phenethyl | | | | |
| | | | butyrate | | | | |
| OLI0102 | eugenol | OLI0088 | furfuryl | | x | 0 | 100 |
| | | | pentanoate | | | | |
| OLI0102 | eugenol | OLI0084 | cis-5- | | x | 0 | 100 |
| | | | octen-1-ol | | | | |
| OLI0102 | eugenol | OLI0078 | (Z)-hept-3- | | x | 0 | 100 |
| | | | enylacetate | | | | |
| OLI0029 | phenyl | OLI0024 | gamma | | x | 0 | 100 |
| | propyl | | heptalactone | | | | |
| | aldehyde | | | | | | |
| OLI0015 | 2,3- | OLI0024 | gamma | | x | 0 | 15 |
| | dimethyl | | heptalactone | | | | |
| | pyrazine | | | | | | |
| OLI0024 | gamma- | OLI0021 | ethyl | | x | 0 | 95 |
| | heptalactone | | 3-hydroxy | | | | |
| | | | hexanoate | | | | |
| OLI0080 | 1-octanol | OLI0102 | eugenol | OLI0071 | 2-ethyl-3- | 0 | 100 |
| | | | | | methoxy | | |
| | | | | | pyrazine | | |
| OLI0102 | eugenol | OLI0078 | (Z)-hept-3- | OLI0071 | 2-ethyl-3- | 0 | 100 |
| | | | enylacetate | | methoxy | | |
| | | | | | pyrazine | | |
| OLI0088 | furfuryl | OLI0071 | 2-ethyl- | OLI0102 | eugenol | 0 | 100 |
| | pentanoate | | 3-methoxy | | | | |
| | | | pyrazine | | | | |
| OLI0100 | methyl (E)- | OLI0068 | 2,3-diethyl | OLI0102 | eugenol | 0 | 85 |
| | hex-3- | | pyrazine | | | | |
| | enoate | | | | | | |
| OLI0100 | methyl (E)- | OLI0068 | 2,3-diethyl | OLI0080 | 1-octanol | 0 | 100 |
| | hex-3- | | pyrazine | | | | |
| | enoate | | | | | | |
| OLI0100 | methyl (E)- | OLI0068 | 2,3-diethyl | OLI0088 | furfuryl | 0 | 95 |
| | hex-3- | | pyrazine | | pentanoate | | |
| | enoate | | | | | | |
| OLI0068 | 2,3-diethyl | OLI0102 | eugenol | OLI0080 | 1-octanol | 0 | 100 |
| | pyrazine | | | | | | |
| OLI0068 | 2,3-diethyl | OLI0102 | eugenol | OLI0078 | (Z)-hept-3- | 0 | 35 |
| | pyrazine | | | | enylacetate | | |
| OLI0022 | ethyl | OLI0021 | ethyl | | x | 0 | 5 |
| | acetoacetate | | 3-hydroxy | | | | |
| | | | hexanoate | | | | |

### Example 17

### Bed Bug Repellency Assay

Compounds and combinations of compounds of the present invention were assayed for their ability to repel bed bugs (Cimex lectularius) using a bed bug repellency assay. This assay takes advantage of the bed bug's natural tendency to seek harborage. Two petri dishes were obtained and the inner areas of each were sanded down (leaving the perimeter smooth.) Talc was applied on the perimeter and on the inside walls of the petri dishes with a small paint brush to prevent bed bugs from escaping. A cut off top portion of a solo bathroom cup was placed upside down in the center of one petri dish. A large plastic secondary container was gathered and a paper towel was laid down inside the bottom. The petri dish was then placed inside and ten bed bugs were placed inside the cut off portion of the solo cup. Next, two pieces of filter paper were cut down the middle to yield 4 equally sized halves. 3 pieces were placed inside a glass dish (100 cm×50 cm or 90 cm×50 cm) and the remaining piece was placed in a separate dish. All 4 pieces were folded down the middle to create a “tent” or “harborage” when laid such that the folded crease faced up. 100 microliters of isopropyl alcohol was pipetted into 3 pieces of filter paper (all housed in the first glass dish.) In a separate 4 ml vial, 90 microliters of isopropyl alcohol was combined and vortexed with 10 microliters of the compound or compound combination being tested. 100 microliters of this solution [comprising a total of 100 mg of compound(s)] was pipetted onto the filter paper in the separate dish. All filter papers were then allowed to dry. Once dry, experiments were conducted first with two filter paper halves comprising only the isopropyl alcohol (control experiment) and then with the remaining filter paper halves [one with only isopropyl alcohol and one comprising the test compound(s).] Filter paper halves were placed on opposing sides of experimental petri dishes and bed bugs were allowed to move freely within the dishes for 5 minutes. Movement of bed bugs beneath each filter paper tent was recorded. Data obtained for each compound tested is listed in Table 20. % repellency represents the % of bed bugs that did not move beneath treated filter paper tents as compared to control. In the Table, “Rep” refers to repellency and “Cmpd” refers to compound. Many compounds and combinations comprising environmentally friendly compounds displayed surprisingly strong ability to repel bed bugs. Some such compounds included citronella oil, eugenol and geraniol.

TABLE 20
Bed bug repellency

| Cmpd | | Cmpd | | % |
|---|---|---|---|---|
| No. | Component A | No. | Component B | Rep |
| OLI0065 | trans-cinnamaldehyde | | X | 100 |
| OLI0102 | Eugenol | | X | 100 |
| OLI0005 | 4-ethylphenol | | X | 100 |
| OLI0052 | Indole | | X | 100 |
| OLI0029 | phenylpropylaldehyde | | X | 100 |
| OLI0072 | 2-methoxy-3(5or6) | | X | 100 |
| | isopropylpyrazine | | | |
| OLI0067 | 2,3-diethyl-5-methylpyrazine | | X | 100 |
| OLI0021 | ethyl 3-hydroxyhexanoate | | X | 100 |
| OLI0074 | Furfurylpentanoate | | X | 100 |
| OLI0107 | cinnamyl formate | | X | 100 |
| OLI0012 | Guaiacol | | X | 100 |
| OLI0121 | phenylacetaldehyde | | X | 100 |
| | dimethyl acetate | | | |
| OLI0068 | 2,3-diethylpyrazine | OLI0070 | 2-methoxy-3-methylpyrazine | 100 |
| OLI0076 | phenethyl propionate | OLI0074 | furfurylpentanoate | 100 |
| OLI0020 | cinnamyl nitrile | OLI0017 | 2-furyl methyl ketone | 100 |
| OLI0020 | cinammyl nitrile | OLI0029 | phenylpropylaldehyde | 100 |
| OLI0020 | cinnamyl nitrile | OLI0029 | phenylpropylaldehyde | 100 |
| OLI0020 | cinnamyl nitrile | OLI0024 | gamma-heptalactone | 100 |
| OLI0017 | 2-furyl methyl ketone | OLI0016 | 2-acetyl-5-methyl furan | 100 |
| OLI0017 | 2-furyl methyl ketone | OLI0015 | 2,3-dimethylpyrazine | 100 |
| OLI0017 | 2-furyl methyl ketone | OLI0014 | 2,3,5-trimethylpyrazine | 100 |
| OLI0016 | 2-acetyl-5-methyl furan | OLI0029 | phenylpropylaldehyde | 100 |
| OLI0016 | 2-acetyl-5-methyl furan | OLI0024 | gamma-heptalactone | 100 |
| OLI0093 | rosemary oil | OLI0102 | eugenol | 100 |
| OLI0102 | Eugenol | OLI0095 | veratraldehyde | 100 |
| OLI0102 | Eugenol | OLI0078 | (Z)-hept-3-enylacetate | 100 |
| OLI0015 | 2,3-dimethyl pyrazine | OLI0014 | 2,3,5-trimethylpyrazine | 100 |
| OLI0106 | cinnamic aldehyde | | X | 90 |
| | dimethyl acetal | | | |
| OLI0020 | cinnamyl nitrile | OLI0015 | 2,3-dimethyl pyrazine | 88 |
| OLI0100 | methyl (E)-hex-3-enoate | OLI0016 | 2-acetyl-5-methyl furan | 88 |
| OLI0059 | Methylheptadienone | | X | 87 |
| OLI0016 | 2-acetyl-5-methyl furan | | X | 86 |
| OLI0020 | cinnamyl nitrile | OLI0014 | 2,3,5-trimethylpyrazine | 85 |
| OLI0118 | Ultrazur | | X | 84 |
| OLI0084 | cis-5-octenol-1-ol | | X | 82 |
| OLI0093 | rosemary oil | OLI0084 | cis-5-octen-1-ol | 79 |
| OLI0015 | 2,3-dimethylpyrazine | | X | 77 |
| OLI0029 | phenylpropylaldehyde | OLI0024 | gamma-heptalactone | 75 |
| OLI0077 | trans-2-decenal | | X | 72 |
| OLI0076 | phenethyl propionate | OLI0077 | trans-2-decenal | 72 |
| OLI0071 | 2-ethyl-3-methoxypyrazine | OLI0077 | trans-2-decenal | 72 |
| OLI0101 | peppermint oil | | X | 71 |
| OLI0024 | gamma-heptalactone | | X | 71 |
| OLI0114 | methyl trans-cinnamate | | X | 70 |
| OLI0113 | methyl cinnamate | | X | 68 |
| OLI0076 | phenthyl propionate | OLI0072 | 2-methoxy-3(5or6) | 65 |
| | | | isopropylpyrazine | |
| OLI0017 | 2-furyl methyl ketone | | X | 60 |
| OLI0115 | Menthol | | X | 60 |
| OLI0119 | hexyl butyrate | | X | 59 |
| OLI0014 | 2,3,5-trimethylpyrazine | | X | 59 |
| OLI0110 | ethyl cinnamate | | X | 59 |
| OLI0020 | cinnanyl nitrile | | X | 56 |
| OLI0104 | allyl cinnamate | | X | 54 |
| OLI0100 | methyl (E)-hex-3-enoate | OLI0024 | gamma-heptalactone | 53 |
| OLI0028 | Phenylacetaldehyde | | X | 50 |
| OLI0002 | 2-ethylpyrazine | | X | 49 |
| OLI0079 | 1-ethylhexyl tiglate | | X | 49 |
| OLI0006 | 5-methyl furfural | | X | 47 |
| OLI0097 | hexyl formate | | X | 44 |
| OLI0016 | 2-acetyl-5-methyl furan | OLI0021 | ethyl 3-hydroxyhexanoate | 43 |
| OLI0100 | methyl (E)-hex-3-enoate | OLI0015 | 2,3-dimethylpyrazine | 43 |
| OLI0009 | ethyl 2-furoate | | X | 41 |
| OLI0109 | cinnamyl propionate | | X | 41 |
| OLI0100 | methyl (E)-hex-3-enoate | OLI0014 | 2,3,5-trimethylpyrazine | 41 |
| OLI0001 | 2,4-lutidine | | X | 39 |
| OLI0026 | methyl crotonate | | X | 38 |
| OLI0010 | Ethyllactate | | X | 37 |
| OLI0004 | 2-methyltetrahydrofuran-3-one | | X | 37 |
| OLI0105 | trans-cinnamyl propionate | | X | 35 |
| OLI0066 | Valeraldehyde | | X | 33 |
| OLI0071 | 2-ethyl-3-methoxypyrazine | | X | 29 |
| OLI0068 | 2,3-diethylpyrazine | | X | 24 |
| OLI0112 | methoxy cinnamic aldehyde | | X | 23 |
| OLI0003 | 2-methoxypyrazine | | X | 22 |
| OLI0120 | benzyl cinnamate | | X | 21 |
| OLI0027 | methyl levulinate | | X | 20 |
| OLI0091 | methyl heptanoate | | X | 20 |
| OLI0099 | isoamyl propionate | | X | 17 |
| OLI0100 | methyl (E)-hex-3-enoate | | X | 17 |
| OLI0011 | Ethylvinylcarbinol | | X | 14 |
| OLI0111 | Menthalactone | | X | 13 |
| OLI0069 | 2-ethyl-3-methylpyrazine | | X | 10 |
| OLI0019 | allyl butyrate | | X | 8 |
| OLI0092 | Methylamylketone | | X | 8 |
| OLI0096 | cis 3-hexenyl formate | | X | 6 |
| OLI0007 | butyl formate | | X | 6 |

### Example 18

### Bed Bug Luring Assay

Assays were conducted to measure the ability of compounds and compound combinations to attract bed bugs. A testing arena habitat comprising a small plastic container was placed inside of a larger, secondary container. The top half inch was removed from two bathroom sized solo cups and each cup was placed on opposite sides of the testing arena habitat, one inch away from the wall. Each outer part of the cup was textured using sandpaper, as bed bugs cannot climb smooth surfaces. A paper towel was used to line the floor of the testing arena habitat. The top, removed portion of one of the solo cups was placed mouth side down in the center of the arena. In one of the cups, a cottonball was placed and treated with 100 microliters of compound or compound combination solution [comprising a total of 100 mg of compound(s).] 10 bed bugs were placed within the center cut off cup top and the testing arena habitat was covered and placed within a dark, climate controlled room overnight. The next day, the number of bed bugs that crawled into the baited cup were recorded and the % attractancy was calculated as the percentage of bugs that crawled into the baited cup as compared to the total number of bed bugs. The data obtained for each compound or combination of compounds tested is presented in Table 21. In the Table, “Att” refers to attractancy and “Cmpd” refers to compound. Some compounds and combinations comprising ethyllactate and/or cyclopentanone displayed surprisingly strong ability to attract bed bugs.

TABLE 21
Bed bug attactancy

| Cmpd | | Cmpd | | |
|---|---|---|---|---|
| No. | Component A | No. | Component B | % Att |
| OLI0010 | Ethyllactate | OLI0011 | ethylvinylcarbinol | 80% |
| OLI0008 | Cyclopentanone | | X | 50% |
| OLI0010 | Ethyllactate | OLI0004 | 2-methyltetrahydrofuran-3-one | 50% |
| OLI0008 | Cyclopentanone | OLI0002 | 2-ethylpyrazine | 40% |
| OLI0010 | Ethyllactate | OLI0007 | butyl formate | 40% |
| OLI0007 | butyl formate | OLI0008 | cyclopentanone | 40% |
| OLI0007 | butyl formate | OLI0003 | 2-methoxypyrazine | 40% |
| OLI0018 | 2-pentanone | | X | 30% |
| OLI0063 | propyl formate | | X | 30% |
| OLI0003 | 2-methoxypyrazine | | X | 30% |
| OLI0097 | hexyl formate | | X | 30% |
| OLI0097 | hexyl formate | OLI0017 | 2-furyl methyl ketone | 30% |
| OLI0025 | methanethiol acetate | | X | 20% |
| OLI0026 | methyl crotonate | | X | 20% |
| OLI0014 | 2,3,5-trimethylpyrazine | OLI0018 | 2-pentanone | 20% |
| OLI0021 | ethyl 3-hydroxyhexanoate | OLI0018 | 2-pentanone | 20% |
| OLI0010 | Ethyllactate | OLI0002 | 2-ethylpyrazine | 20% |
| OLI0022 | Ethylacetoacetate | OLI0017 | 2-furyl methyl ketone | 20% |
| OLI0022 | Ethylacetoacetate | OLI0016 | 2-acetyl-5-methyl furan | 20% |
| OLI0070 | 2-methoxy-3-methylpyrazine | | X | 10% |
| OLI0099 | isoamyl propionate | | X | 10% |
| OLI0027 | methyl levulinate | | X | 10% |
| OLI0029 | phenylpropylaldehyde | OLI0024 | gamma-heptalactone | 10% |
| OLI0014 | 2,3,5-trimethylpyrazine | OLI0028 | phenylacetaldehyde | 10% |
| OLI0008 | Cyclopentanone | OLI0001 | 2,4-lutidine | 10% |
| OLI0007 | butyl formate | OLI0004 | 2-methyltetrahydrofuran-3-one | 10% |
| OLI0008 | Cyclopentanone | OLI0022 | ethylacetoacetate | 10% |
| OLI0022 | Ethylacetoacetate | OLI0021 | ethyl 3-hydroxyhexanoate | 10% |

1. A composition comprising at least one of compounds OLI0001-OLI0121.

2-4. (canceled)

5. The composition of claim 1, wherein said composition comprises an activator combination of at least two compounds, wherein at least one compound is selected from the group consisting of OLI0001-OLI0004, OLI0006-OLI0008, OLI0010, OLI0011, OLI0013-OLI0022, OLI0024-OLI0029, OLI0063, OLI0091, OLI0092 and OLI0096-OLI0100.

6-7. (canceled)

8. The composition of claim 5, wherein at least one compound is a beta activator selected from the group consisting of OLI0027, OLI0096, OLI0097 and OLI0099.

9-12. (canceled)

13. The composition of claim 5, wherein said composition comprises a synergistic combination of at least two activator compounds selected from the group consisting of OLI0014-OLI0018, OLI0022, OLI0024, OLI0025, OLI0027 and OLI0029.

14-15. (canceled)

16. The composition of claim 1, wherein said composition comprises at least one inhibitor compound selected from the group consisting of OLI0067-OLI0095.

17. The composition of claim 1, wherein said composition comprises an inhibitory combination of at least two compounds selected from the group consisting of OLI0015, OLI0067-OLI0078, OLI0080, OLI0082-OLI0084, OLI0089, OLI0093, OLI0095, 0110100 and OLI0102.

18-19. (canceled)

20. The composition of claim 17, wherein said composition comprises at least one beta activator selected from the group consisting of OLI0074, OLI0084 and OLI0100.

21. The composition of claim 17, wherein said composition comprises a synergistic combination comprising at least two compounds selected from the group consisting of OLI0015, OLI0071-OLI0078, OLI0080, OLI0082-OLI0084, OLI0089, OLI0093, OLI0095, OLI0100 and OLI0102.

22. The composition of claim 17, wherein said composition comprises at least one environmentally friendly compound selected from the group consisting OLI0076, OLI0093 and OLI0102.

23-27. (canceled)

28. A method of modifying the behavior of a vector pest comprising exposing said vector pest to a composition according to claim 1.

29. (canceled)

30. The method of claim 28, wherein said vector pest is a flying dipteran, mosquito, sand fly, black fly, tsetse fly, biting midge, bed bug, assassin bug, flea, louse, mite and/or tick.

31. The method of claim 30, wherein vector pest behavioral modification comprises attraction of said vector pest comprising the use of a composition comprising at least one activator compound selected from the group consisting of OLI0001-OLI0066.

32. The method of claim 30, wherein vector pest behavioral modification comprises vector pest attraction comprising the use of a composition comprising an activator combination of at least two compounds, wherein at least one compound is selected from the group consisting of OLI0001-OLI0004, OLI0006-OLI0008, OLI0010, OLI0011, OLI0013-OLI0022, OLI0024-OLI0029, OLI0063, OLI0091, OLI0092 and OLI0096-OLI100.

33-34. (canceled)

35. The method of claim 31, wherein the flying dipteran is selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)).

36-38. (canceled)

39. The method of claim 32, wherein the concentration of each compound is at least 0.01%.

40. The method of claim 39, wherein the concentration of each compound is from about 0.5% to about 5%.

41. The method of claim 32, wherein said composition comprises a synergistic combination of at least two activator compounds selected from the group consisting of OLI0014-OLI0018, OLI0022, OLI0024, OLI0025, OLI0027 and OLI0029.

42-46. (canceled)

47. The method of claim 30, wherein vector pest behavioral modification comprises repelling said vector pest comprising the use of a composition comprising at least one inhibitor compound selected from the group consisting of OLI0067-OLI0095.

48-50. (canceled)

51. The method of claim 47, wherein said composition comprises an inhibitory combination of at least two compounds, wherein at least one compound is selected from the group consisting of OLI0015, OLI0067-OLI0078, OLI0080, OLI0082-OLI0084, OLI0089, OLI0093, OLI0095, 0110100 and OLI0102.

52-53. (canceled)

54. The method of claim 51, wherein the flying dipteran is selected from the group consisting of one or more members of the mosquito family Culicidae (including, but not limited to one or more members of the genus Aedeomyia, one or more members of the genus Aedes (including, but not limited to Aedes aegypti), one or more members of the genus Anopheles (including, but not limited to Anopheles gambiae and Anopheles annulipes), one or more members of the genus Armigeres, one or more members of the genus Ayurakitia, one or more members of the genus Bironella, one or more members of the genus Borichinda, one or more members of the genus Chagasia, one or more members of the genus Coquillettidia, member of the genus Culex (including, but not limited to Culex quinquefasciatus, Culex molestus, Culex annulirostris and Culex australicus), one or more members of the genus Culiseta, one or more members of the genus Deinocerites, one or more members of the genus Eretmapodites, one or more members of the genus Ficalbia, one or more members of the genus Galindomyia, one or more members of the genus Haemagogus, one or more members of the genus Heizmannia, one or more members of the genus Hodgesia, one or more members of the genus Isostomyia, one or more members of the genus Johnbelkinia, one or more members of the genus Kimia, one or more members of the genus Limatus, one or more members of the genus Lutzia, one or more members of the genus Malaya, one or more members of the genus Mansonia, one or more members of the genus Maorigoeldia, one or more members of the genus Mimomyia, one or more members of the genus Onirion, one or more members of the genus Opifex, one or more members of the genus Orthopodomyia, one or more members of the genus Psorophora, one or more members of the genus Runchomyia, one or more members of the genus Sabethes, one or more members of the genus Shannoniana, one or more members of the genus Topomyia, one or more members of the genus Toxorhynchites, one or more members of the genus Trichoprosopon, one or more members of the genus Tripteroides, one or more members of the genus Udaya, one or more members of the genus Uranotaenia, one or more members of the genus Verrallina, one or more members of the genus Wyeomyia, one or more members of the genus Zeugnomyia), Tsetse flies of the genus Glossina (including, but not limited to Glossina austeni, Glossina morsitans, Glossina pallidipes, Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to one or more members of the genus Culicoides (including, but not limited to Culicoides sonorensis), one or more members of the genus Leptoconops (including, but not limited to Leptoconops albiventris and Leptoconops torrens) and one or more members of the genus Forcipomyia), black flies of the family Simuliidae (including, but not limited to one or more members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to one or more members of the genus Lutzomyia (including, but not limited to Lutzomyia longipalpis) and one or more members of the genus Phlebotomus (including, but not limited to Phlebotomus papatasi)).

55. (canceled)

56. The method of claim 54, wherein the concentration of each compound is at least 0.01%.

57. The method of claim 56, wherein the concentration of each compound is from about 0.01% to about 5%.

58. (canceled)

59. The method of claim 30, wherein said vector pest is a bed bug and wherein said composition comprises one repellent compound selected from the group consisting of OLI0005, OLI0012, OLI0015-OLI0017, OLI0021, OLI0024, OLI0029, OLI0052, OLI0059, OLI0065, OLI0067, OLI0072, OLI0074, OLI0077, OLI0084, OLI0101, OLI0102, OLI0106, OLI0107, OLI0113-OLI0115, OLI0118 and OLI0121.

60. The method of claim 30, wherein said vector pest is a bed bug and wherein said composition comprises a repellent combination of two compounds that:
a) are selected from the group consisting of OLI0014-OLI0016, OLI0024, OLI0029, OLI0068, OLI0070-OLI0072, OLI0074, OLI0076-OLI0078, OLI0084, OLI0093, OLI0095, 0110100 and OLI0102,
b) comprise OLI0017 and a compound selected from OLI0014 and OLI0015, or
c) comprise OLI0020 and OLI0029.

61-62. (canceled)

63. The method of claim 30, wherein said vector pest is a bed bug and wherein said composition comprises at least one attractant compound selected from the group consisting of OLI0004, OLI0008, OLI0010 and OLI0011.

64. (canceled)

65. A method of killing a vector pest comprising exposing said vector pest to a composition according to claim 1.

66-72. (canceled)

73. A patch comprising at least one of compounds OLI0001-OLI0102.

74. (canceled)

75. The patch of claim 73, wherein said patch is comprised of one or more materials selected from the group consisting of paper, plastic, metal, fabric, wax, polymeric materials, polyethylene, polypropylene, rubber, cellulose, silicon rubber and cellulose-based materials.

76. The patch of claim 75, wherein said patch comprises:
a) an area from about 1 cm² to about 5 cm²,
b) a shape selected from the group consisting of a circle, a square, a rectangle, a triangle and a polygon, and
c) optionally comprises an adhesive.

77-80. (canceled)

81. A method of repelling a vector pest comprising the patch of claim 77.

82-85. (canceled)
